(19) United States
(12) Patent Application Publication
(10) Pub. No.: US 2008/0163276 A1
(43) Pub. Date: Jul. 3, 2008

(54) ELECTRONIC EQUIPMENT

(75) Inventor: Zentaro Ueda, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/956,225

(22) Filed: Dec. 13, 2007

(30) Foreign Application Priority Data
Dec. 27, 2006 (JP) 2006-352608

(51) Int. Cl. G11B 33/02

(52) U.S. Cl. 720/647

(57) ABSTRACT

Electronic equipment is provided. The electronic equipment includes an enclosure having a recording medium inserting-ejecting opening through which a recording medium inserted and ejected; a cover that may open and close the recording medium inserting-ejecting opening; and a shaft support mechanism supporting the cover to be movable with respect to the enclosure. The shaft support mechanism includes an axial movement part supporting the cover that is movable in a direction approximately perpendicular to the recording medium inserting-ejecting opening; and a circumferential movement part supporting the cover that is movable in a direction approximately horizontal to the recording medium inserting-ejecting opening.

### CROSS REFERENCES TO RELATED APPLICATIONS

The present application claims priority to Japanese Patent Application JP 2006-352608 filed in the Japanese Patent Office Dec. 27, 2006, the entire contents of which is being incorporated herein by reference.

### BACKGROUND

The present application relates to electronic equipment having a recording medium detachably attached that can record and/or reproduce information signals on the recording medium. More particularly, the present application relates to a cover opening and closing mechanism that opens and closes a recording medium in setting-ejecting opening through which a recording medium inserted and ejected.

Japanese Unexamined Patent Application Publication No. 2005-71426 discloses an example of such electronic equipment of the related art. The Publication discloses an imaging device using a disc-shaped recording medium that can record and/or reproduce information signals on the disc-shaped recording medium. The imaging device disclosed in using a disc-shaped recording medium “includes an opening/closing cover openably and closably provided on a side with a hand strap of a disc side panel in an exterior case main body having a disc-shaped recording medium detachably attached, the opening/closing cover formed slidably to an opening of the exterior case main body having the disc-shaped recording medium mounted.”

In the imaging device using a disc-shaped recording medium having such a configuration, it is expected that “a disc-shaped recording medium such as DVD may be exchanged by opening and closing the disc opening/closing cover without being hindered by the hand strap provided on a disc opening/closing cover side” (paragraph [0027] of the specification).

The imaging device disclosed in Japanese Unexamined Patent Application Publication No. 2005-71426 using a disc-shaped recording medium includes an exterior case enclosure having a recording medium inserting-ejecting opening through which a recording medium inserted and ejected; and a disc opening/closing cover moved with respect to the enclosure in a direction to rotate the cover around one pivot point. Accordingly, it may be necessary to rotate the cover on a flat surface in order to avoid interference between the enclosure and the cover. Therefore, the enclosure may not be completely covered with the cover when the enclosure has a notch or the like, giving a clearance between the enclosure and the cover. For this reason, the enclosure is only loosely closed by the cover, so that dust may enter the enclosure to cause failures, disadvantageously.

Electronic equipment of the related art includes a cover moved with respect to an enclosure in a direction to rotate the cover around one pivot point. It may be necessary to move the cover on a flat surface in order to avoid interference between the enclosure and the cover. Therefore, the enclosure having a notch or the like may not be completely covered with the cover, giving a clearance between the enclosure and the cover. For this reason, the enclosure is only loosely closed by the cover, so that dust may enter the enclosure to cause failures.

### SUMMARY

Electronic equipment according to an embodiment includes an enclosure having a recording medium inserting-ejecting opening through which a recording medium inserted and ejected; a cover that may open and close the recording medium inserting-ejecting opening; and a shaft support mechanism supporting the cover to be movable with respect to the enclosure. The shaft support mechanism has an axial movement part supporting the cover that is movable in a direction approximately perpendicular to the recording medium inserting-ejecting opening; and a circumferential movement part supporting the cover that is movable in a direction approximately horizontal to the recording medium inserting-ejecting opening.

In electronic equipment according to an embodiment, interference between an enclosure and a cover when opening and closing the cover may be avoided and a recording medium inserting-ejecting opening may be completely covered with the cover, so that the enclosure may be more tightly closed by the cover and dust from outside may be prevented from entering the enclosure. Further, since a rotation center of the cover may be located in any position in the enclosure, the equipment itself may be reduced in size.

Additional features and advantages are described herein, and will be apparent from, the following Detailed Description and the figures.

### BRIEF DESCRIPTION OF THE FIGURES

FIG. 1 is a rear perspective view of a digital camcorder as a specific example of an imaging device shown as a first example of electronic equipment according to an embodiment.

FIG. 2 is a perspective view of a digital camcorder with a cover opened as a specific example of an imaging device shown as a first example of electronic equipment according to an embodiment.

FIG. 3 is a front perspective view of a digital camcorder as a specific example of an imaging device shown as a first example of electronic equipment according to an embodiment.

FIG. 4 shows a disc side panel forming an enclosure in a first example of electronic equipment according to an embodiment, where FIG. 4A is a front perspective view and FIG. 4B is a plan view.

FIG. 5 shows a disc side panel forming an enclosure in a first example of electronic equipment according to an embodiment, where FIG. 5A is a side view and FIG. 5B is a front view.

FIG. 6 shows a disc side panel forming an enclosure in a first example of electronic equipment according to an embodiment, where FIG. 6A is a bottom view and FIG. 6B is a bottom perspective view.

FIG. 7 is an exploded perspective view showing a disc side panel forming an enclosure in a first example of electronic equipment according to an embodiment.

FIG. 8 only shows a disc side panel forming an enclosure in a first example of electronic equipment according to an embodiment, where FIG. 8A is a front perspective view and FIG. 8B is a bottom perspective view.

FIG. 9 shows a cover member forming a cover in a first example of electronic equipment according to an embodiment, where FIG. 9A is a perspective view and FIG. 9B is a bottom view.

FIG. 10 shows a plate member forming a cover in a first example of electronic equipment according to an embodiment, where FIG. 10A is a perspective view and FIG. 10B is a plan view.

FIG. 11 is a perspective view of a support bracket in a first example of electronic equipment according to an embodiment.

FIG. 12 is a perspective view of a rotation bracket in a first example of electronic equipment according to an embodiment.

FIG. 13 is a perspective view showing a shaft support mechanism in a first example of electronic equipment according to an embodiment.

FIG. 14 is a side view of a shaft support mechanism in a first example of electronic equipment according to an embodiment.

FIG. 15 shows a circumferential movement part in a first example of electronic equipment according to an embodiment, where FIG. 15A is an exploded perspective view showing a circumferential movement part and a rotation bracket and FIG. 15B is an exploded perspective view showing a second pressing member and a rotation shaft.

FIG. 16 is a perspective view showing a relation between a circumferential movement part and a plate member in a first example of electronic equipment according to an embodiment.

FIG. 17 shows a cover and a shaft support mechanism in a first example of electronic equipment according to an embodiment, where FIG. 17A is a perspective view and FIG. 17B is a front view.

FIG. 18 shows a plate member and a shaft support mechanism in a first example of electronic equipment according to an embodiment, where FIG. 18A is a plan view and FIG. 18B is a front view.

FIG. 19 is a perspective view showing a state where a cover is moved in a direction approximately perpendicular to a recording medium inserting-ejecting opening in a first example of electronic equipment according to an embodiment.

FIG. 20 shows a state where a cover is moved in a direction approximately perpendicular to a recording medium inserting-ejecting opening in a first example of electronic equipment according to an embodiment, where FIG. 20A is a front view and FIG. 20B is a bottom view.

FIG. 21 shows a relation between a cover and a shaft support mechanism in a state where the cover is moved in a direction approximately perpendicular to a recording medium inserting-ejecting opening in a first example of electronic equipment according to an embodiment, where FIG. 21A is a perspective view and FIG. 21B is a front view.

FIG. 22 shows a relation between a shaft support mechanism and a plate member in a state where a cover is moved in a direction approximately perpendicular to a recording medium inserting-ejecting opening in a first example of electronic equipment according to an embodiment, where FIG. 22A is a plan view and FIG. 22B is a front view.

FIG. 23 is a perspective view showing a state where a cover is moved in a direction approximately horizontal to a recording medium inserting-ejecting opening in a first example of electronic equipment according to an embodiment.

FIG. 24 shows a state where a cover is moved in a direction approximately horizontal to a recording medium inserting-ejecting opening in a first example of electronic equipment according to an embodiment, where FIG. 24A is a front view and FIG. 24B is a bottom view.

FIG. 25 shows a relation between a cover and a shaft support mechanism in a state where the cover is moved in a direction approximately horizontal to a recording medium inserting-ejecting opening in a first example of electronic equipment according to an embodiment, where FIG. 25A is a perspective view and FIG. 25B is a front view.

FIG. 26 shows a relation between a plate member and a shaft support mechanism in a state where the cover is moved in a direction approximately horizontal to a recording medium inserting-ejecting opening in a first example of electronic equipment according to an embodiment, where FIG. 26A is a plan view and FIG. 26B is a front view.

FIG. 27 is a schematic view showing a cover and a shaft support mechanism in a second example of electronic equipment according to an embodiment.

FIG. 28 shows a cover and a shaft support mechanism in a second example of electronic equipment according to an embodiment, where FIG. 28A is a front view of a state where the cover is closed and FIG. 28B is a front view of a state where the cover is moved in a direction approximately perpendicular to a recording medium inserting-ejecting opening.

### DETAILED DESCRIPTION

A shaft support mechanism has an axial movement part supporting the cover that is movable in a direction approximately perpendicular to the recording medium inserting-ejecting opening; and a circumferential movement part supporting the cover that is movable in a direction approximately horizontal to the recording medium inserting-ejecting opening. Therefore, electronic equipment is realized with a simple configuration, where interference between an enclosure and a cover when opening and closing the cover may be avoided, the enclosure may be more tightly closed by the cover even if the enclosure has a notch or the like, and dust from outside may be prevented from entering the enclosure.

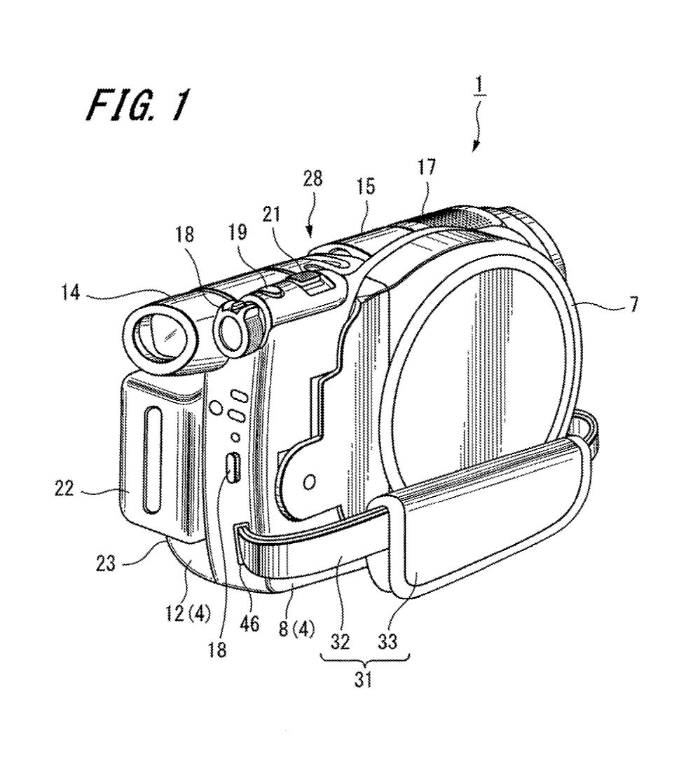

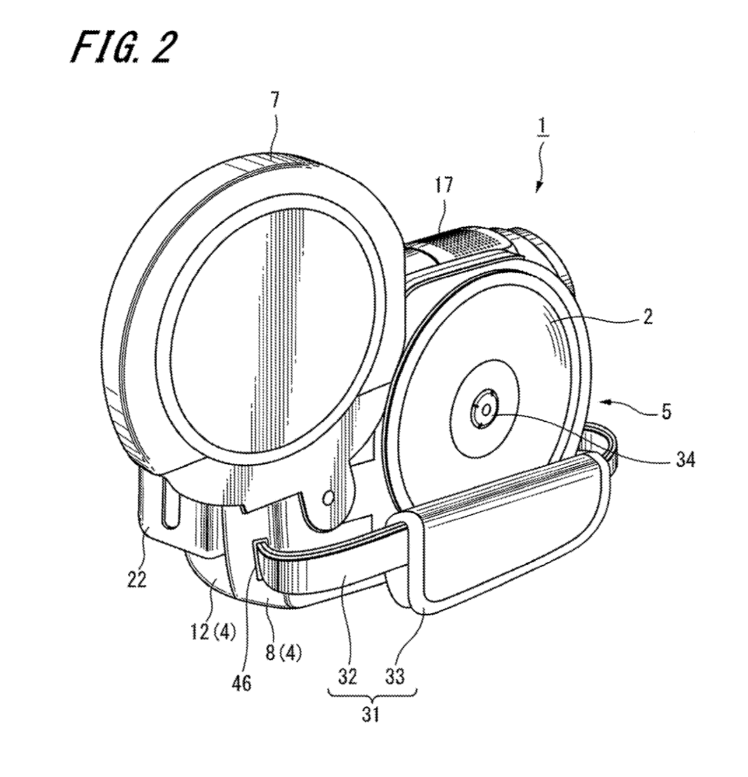

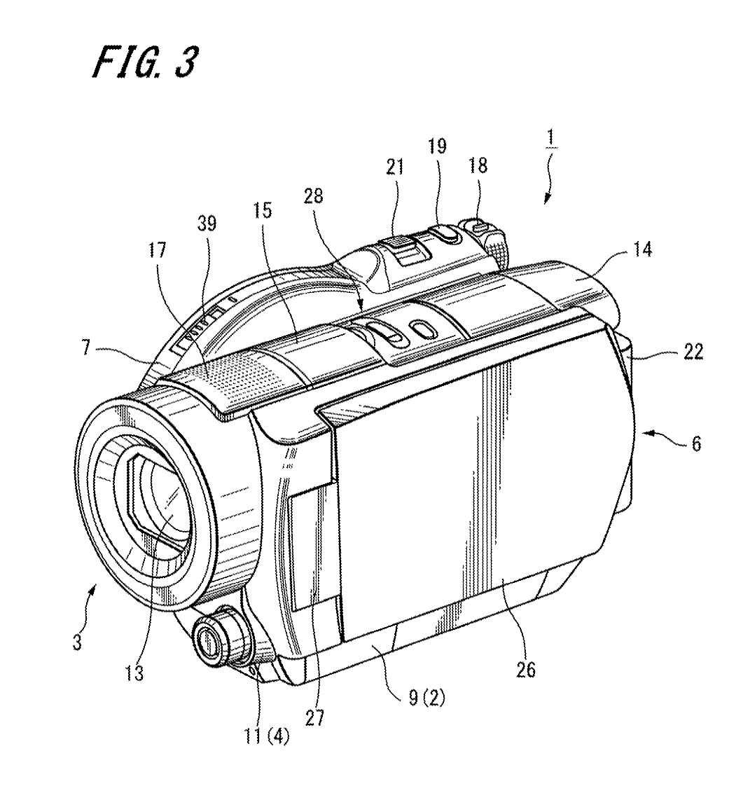

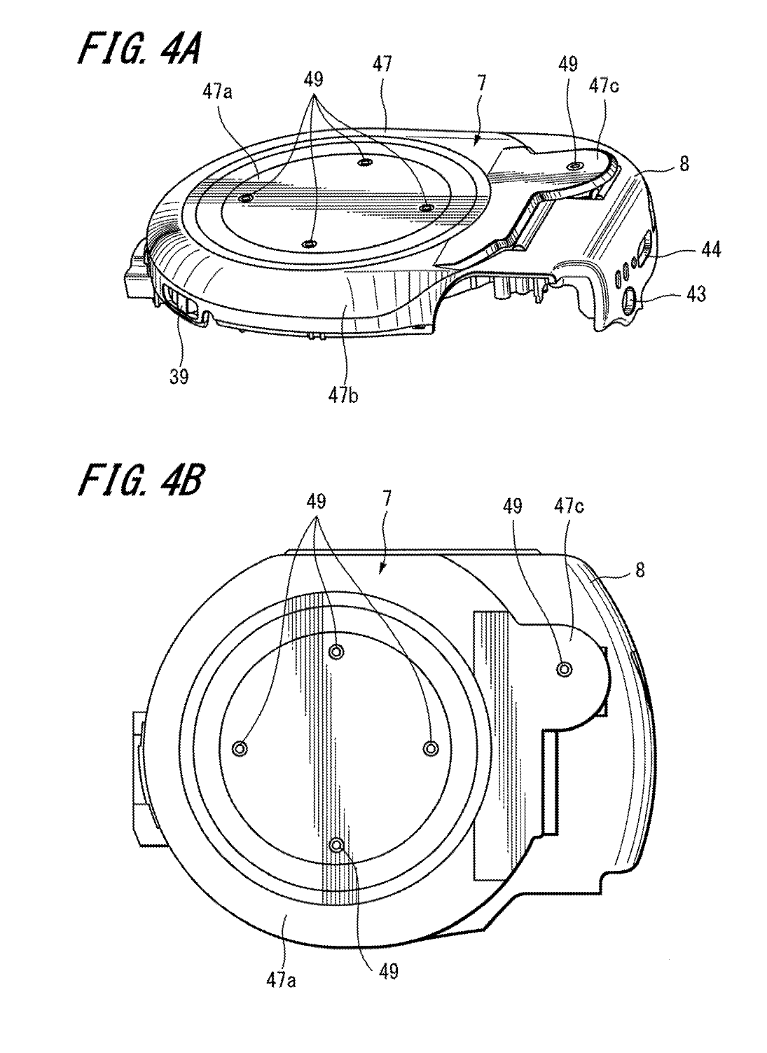

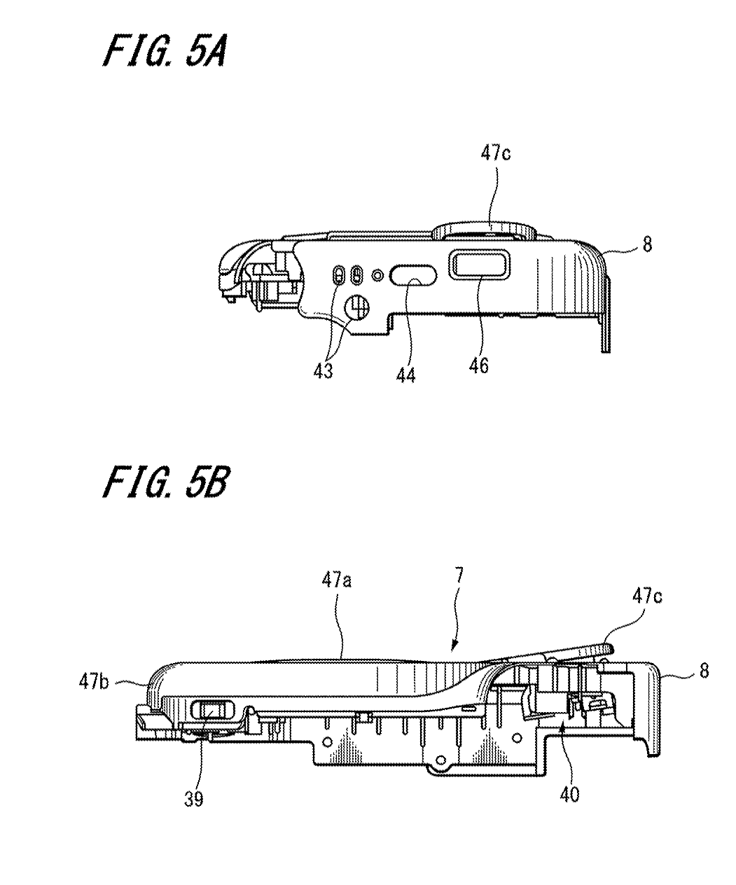

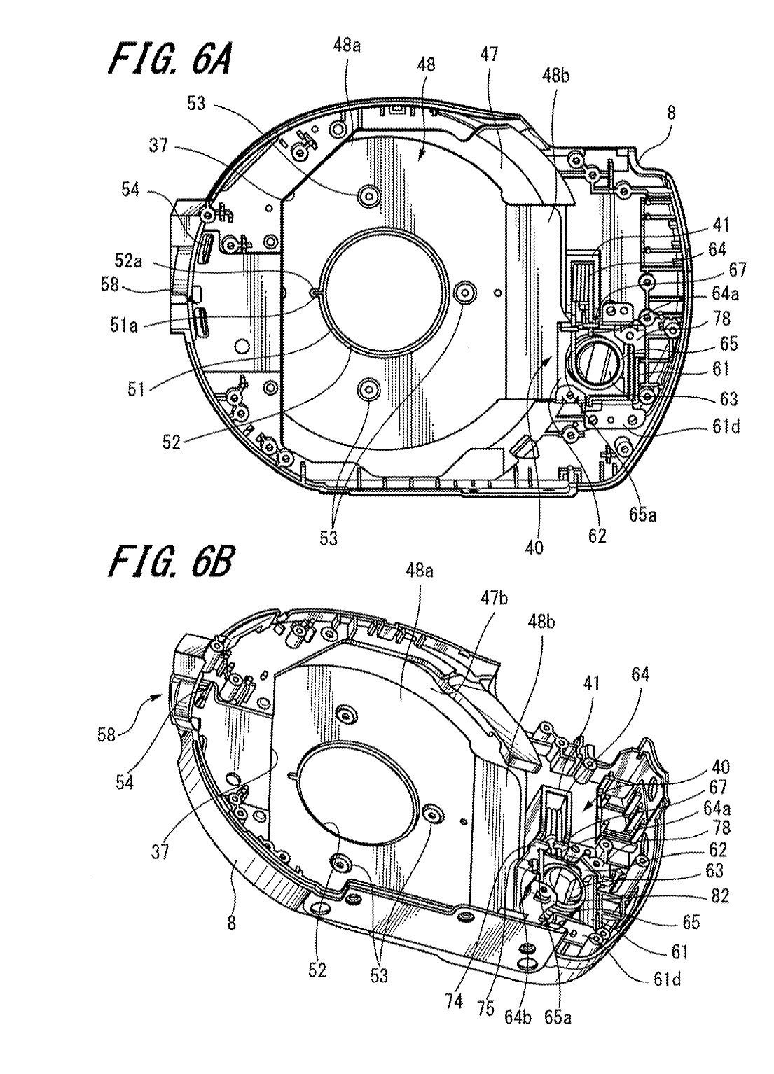

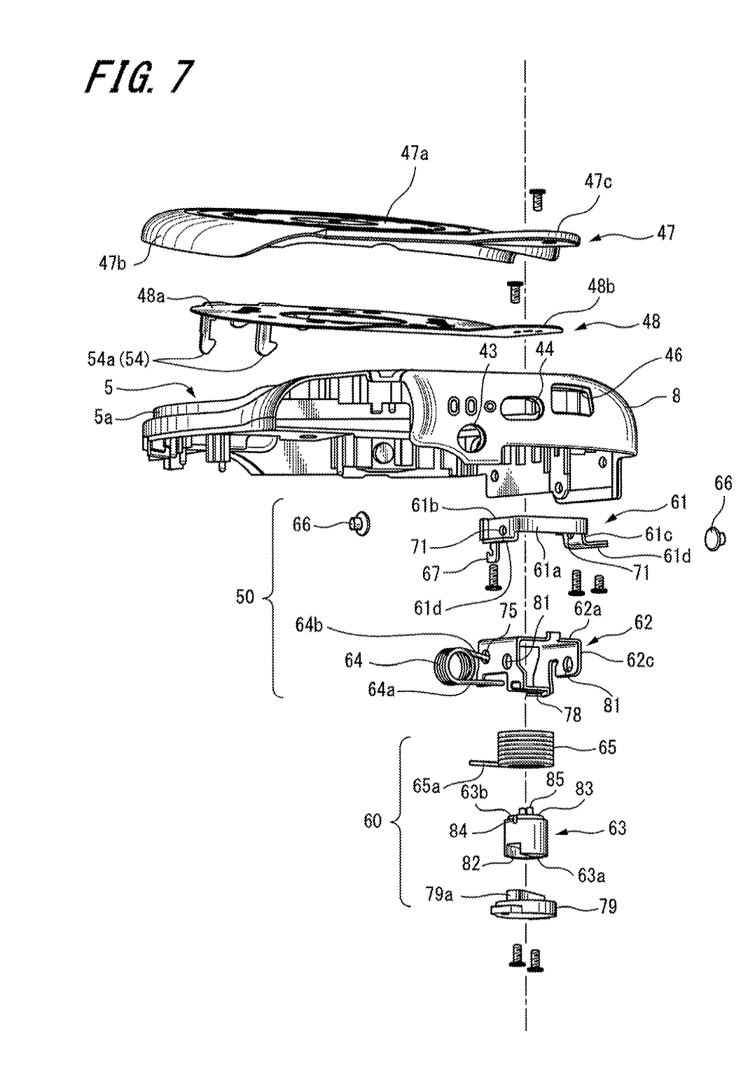

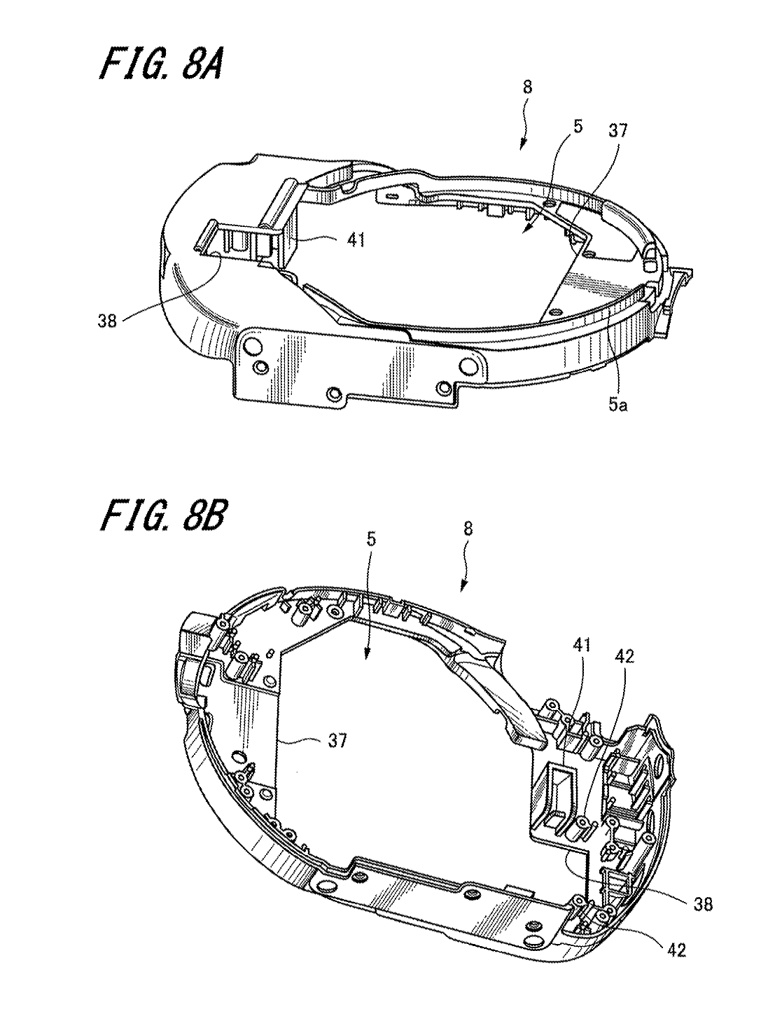

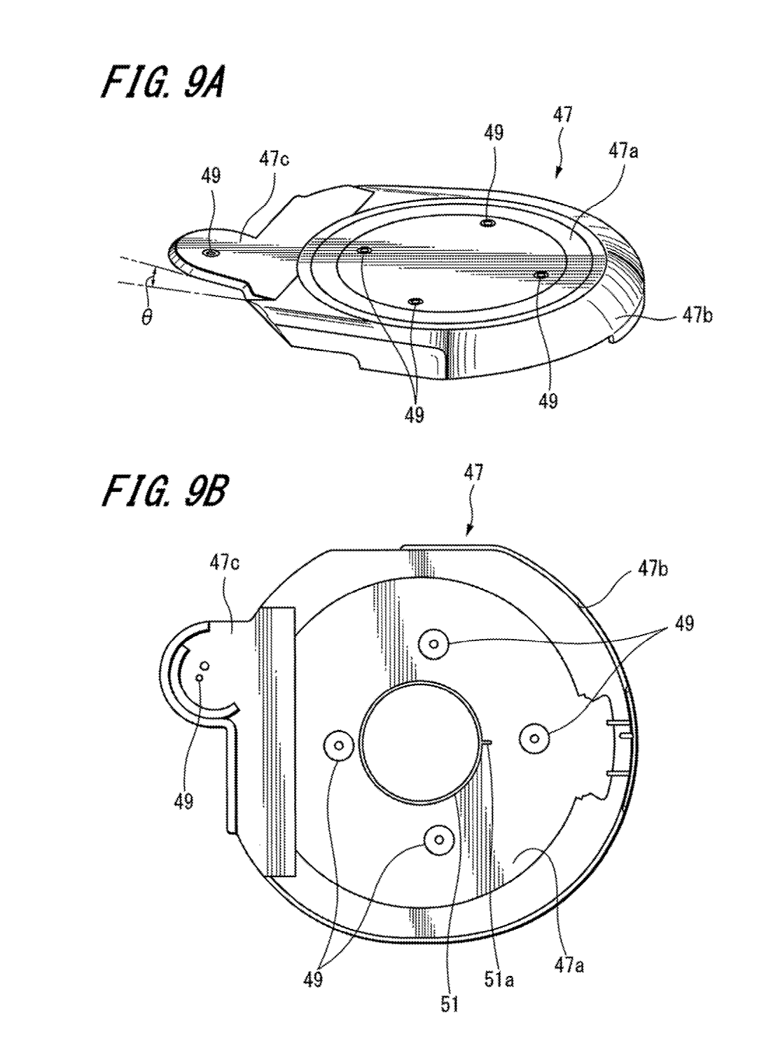

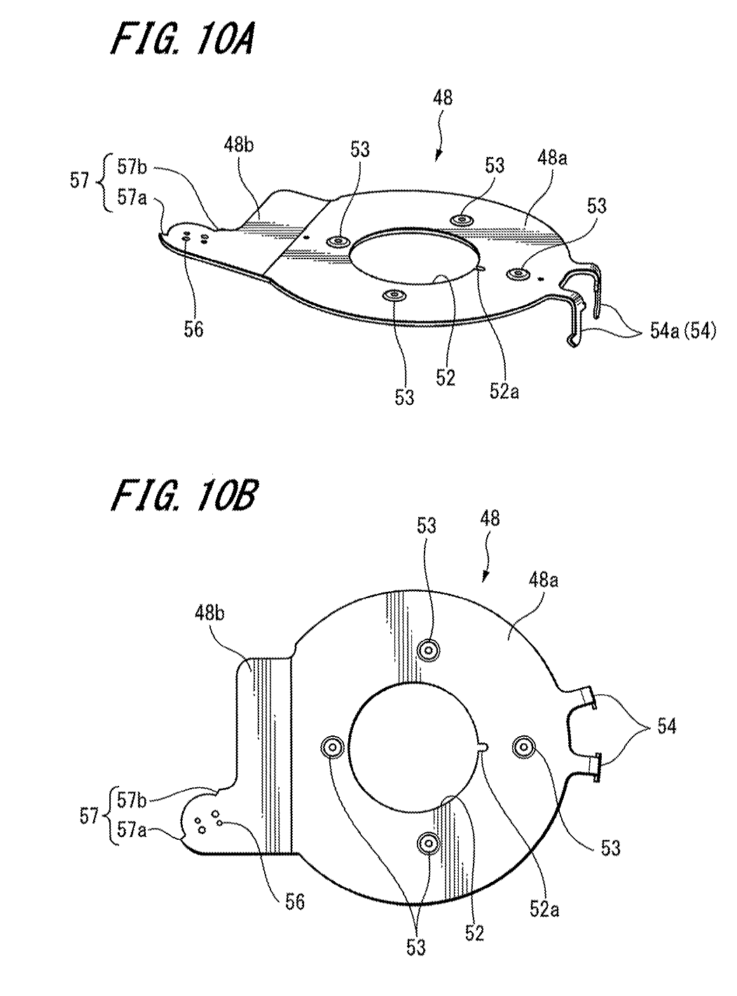

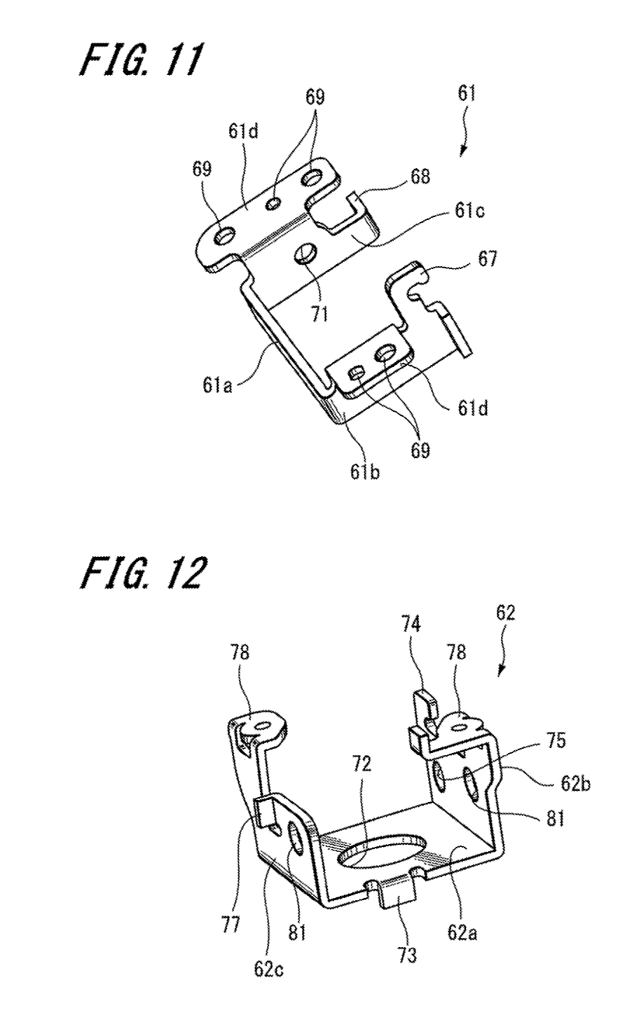

An embodiment will be described below with reference to attached drawings. FIGS. 1 to 28 show an example of an embodiment. That is, FIGS. 1 to 26 show an imaging device as a first example of electronic equipment according to an embodiment of the present application. FIG. 1 is a rear perspective view of an imaging device. FIG. 2 is a perspective view of an imaging device with a cover opened. FIG. 3 is a front perspective view of an imaging device. FIG. 4A is a perspective view, FIG. 4B is a plan view, FIG. 5A is a side view, FIG. 5B is a front view, FIG. 6A is a bottom view, FIG. 6B is a bottom perspective view, and FIG. 7 is an exploded perspective view showing a disc side panel forming an enclosure, respectively. FIGS. 8A and 8B show only a disc side panel, where FIG. 8A is a front perspective view and FIG. 8B is a bottom perspective view. FIGS. 9A and 9B show a cover member forming an enclosure, where FIG. 9A is a perspective view and FIG. 9B is a bottom view. FIGS. 10A and 10B show a plate member forming an enclosure, where FIG. 10A is a perspective view and FIG. 10B is a plan view. FIG. 11 is a perspective view of a support bracket. FIG. 12 is a perspective view of a rotation bracket.

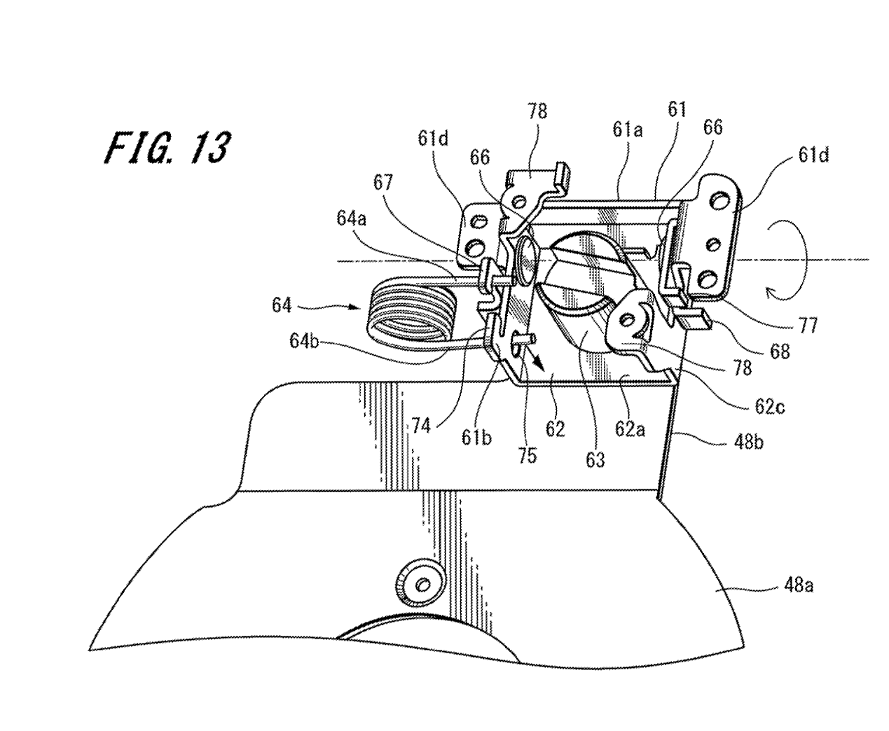

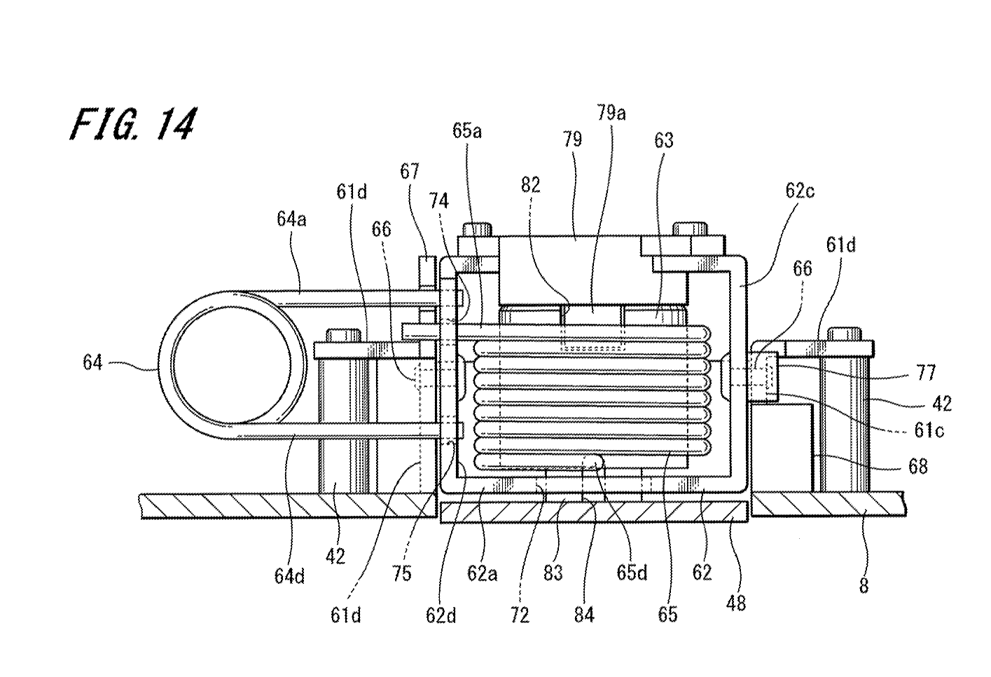

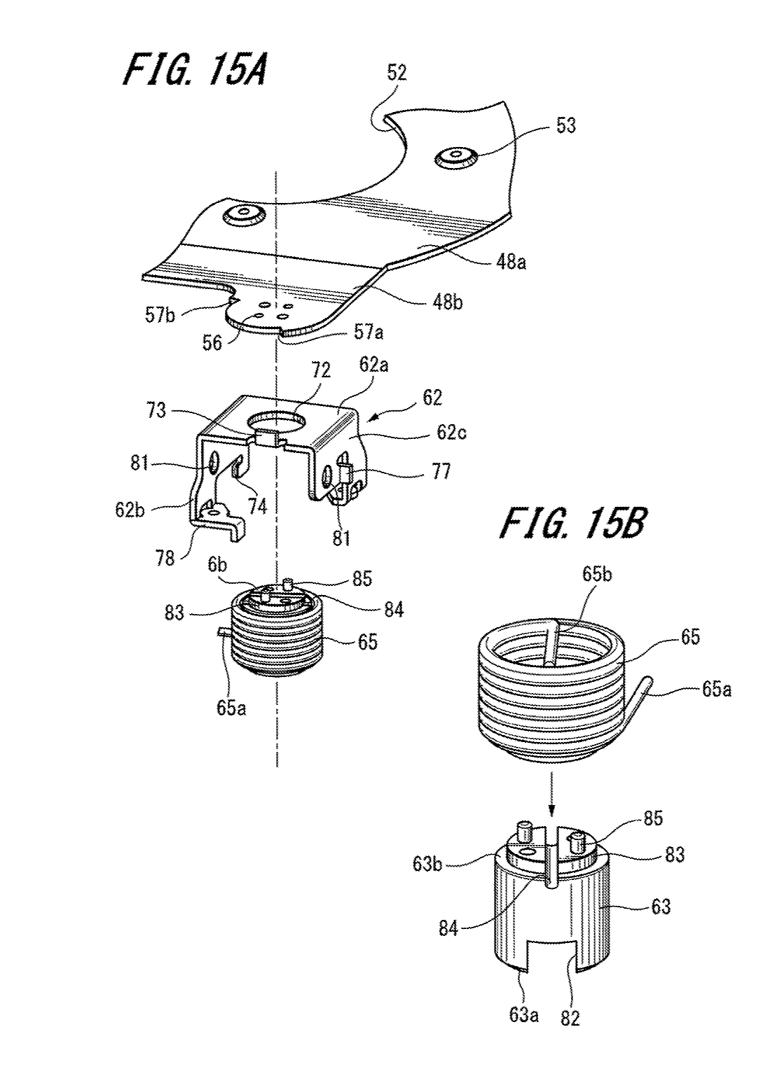

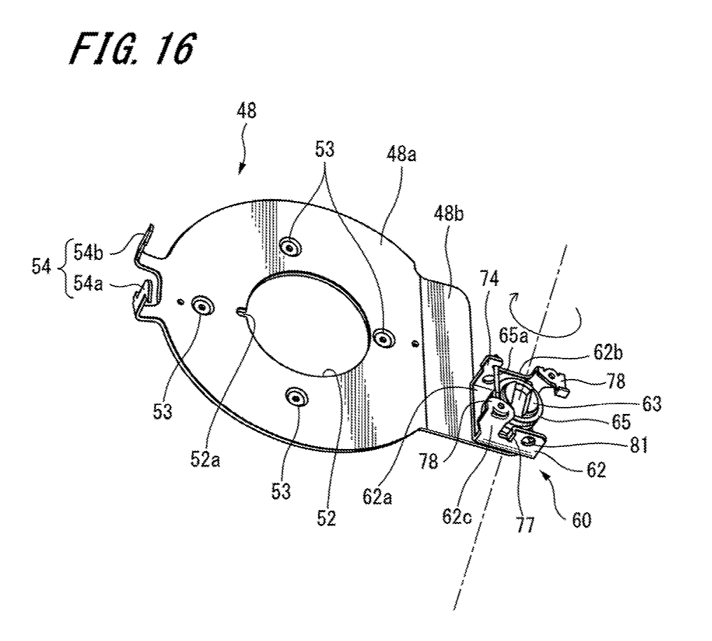

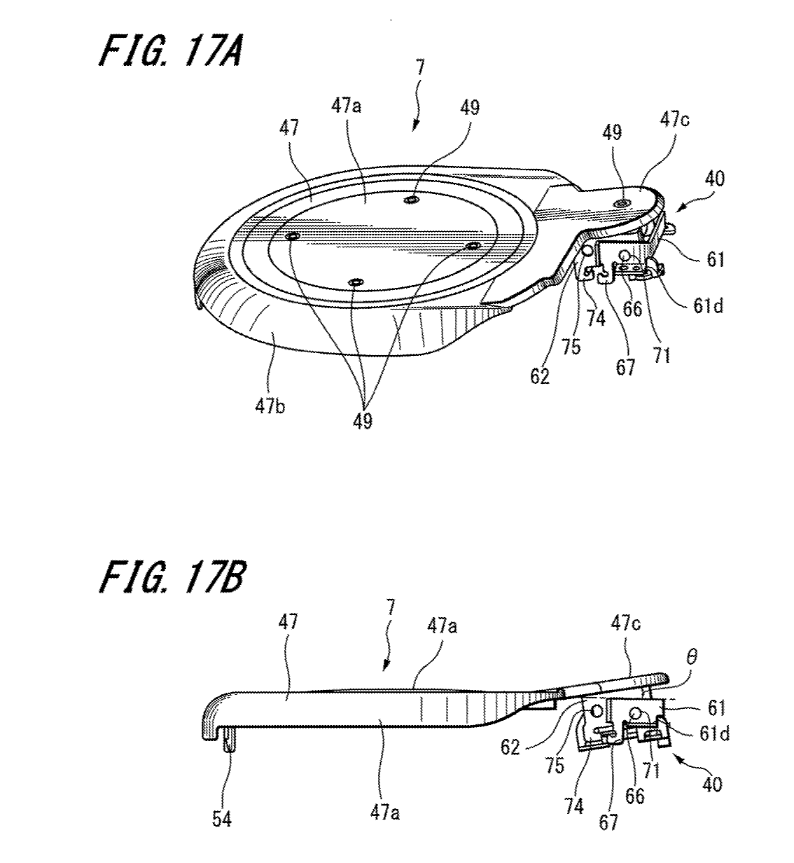

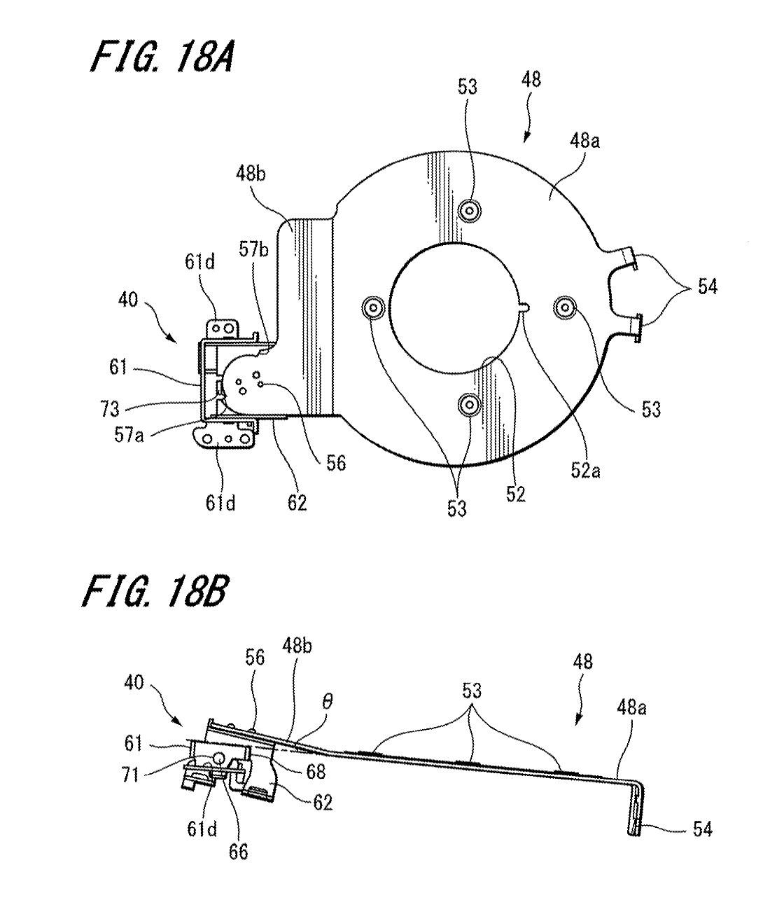

FIG. 13 is a perspective view showing a shaft support mechanism. FIG. 14 is a side view of a shaft support mechanism. FIG. 15A is an exploded perspective view showing a circumferential movement part and a rotation bracket and FIG. 15B is an exploded perspective view showing a second pressing member and a rotation shaft. FIG. 16 is a perspective view showing a relation between a circumferential movement part and a plate member. FIGS. 17A and 17B show a cover and a shaft support mechanism, where FIG. 17A is a perspective view and FIG. 17B is a front view. FIGS. 18A and 18B show a plate member and a shaft support mechanism, where FIG. 18A is a plan view and FIG. 18B is a front view.

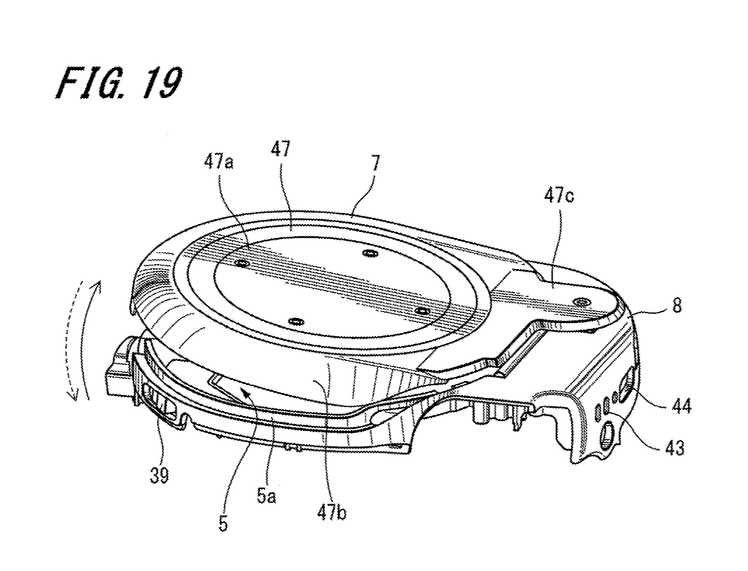

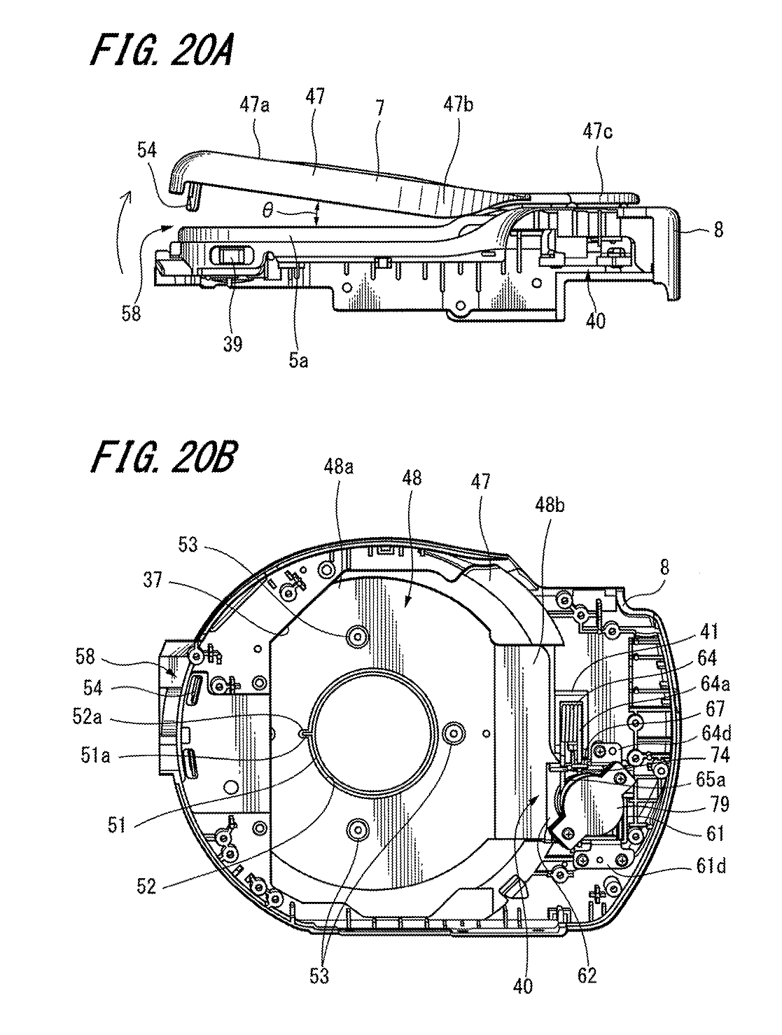

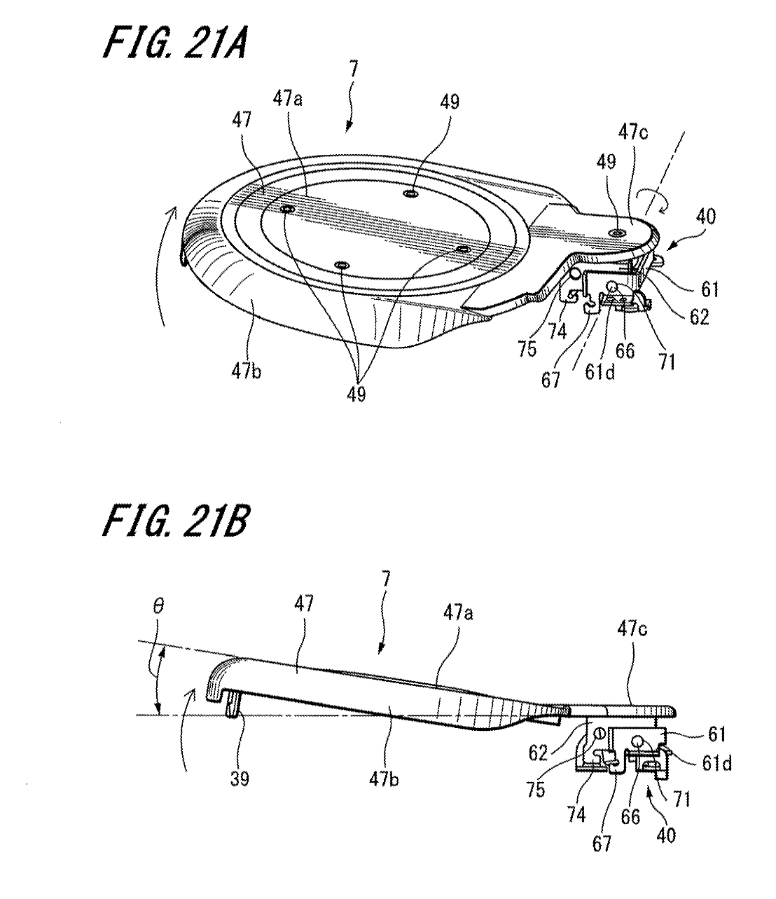

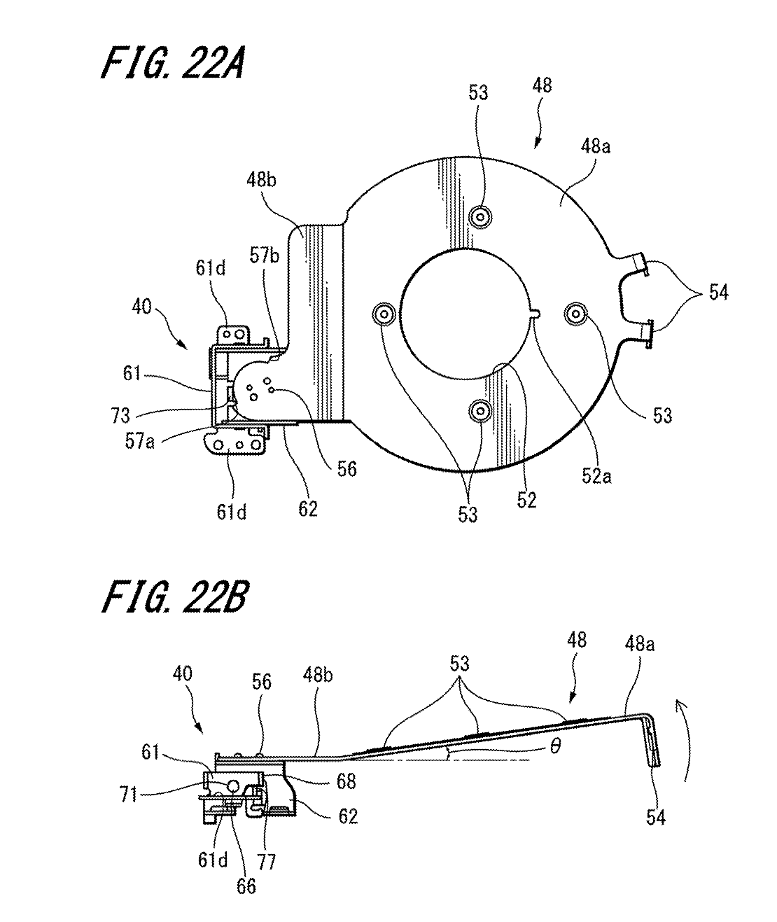

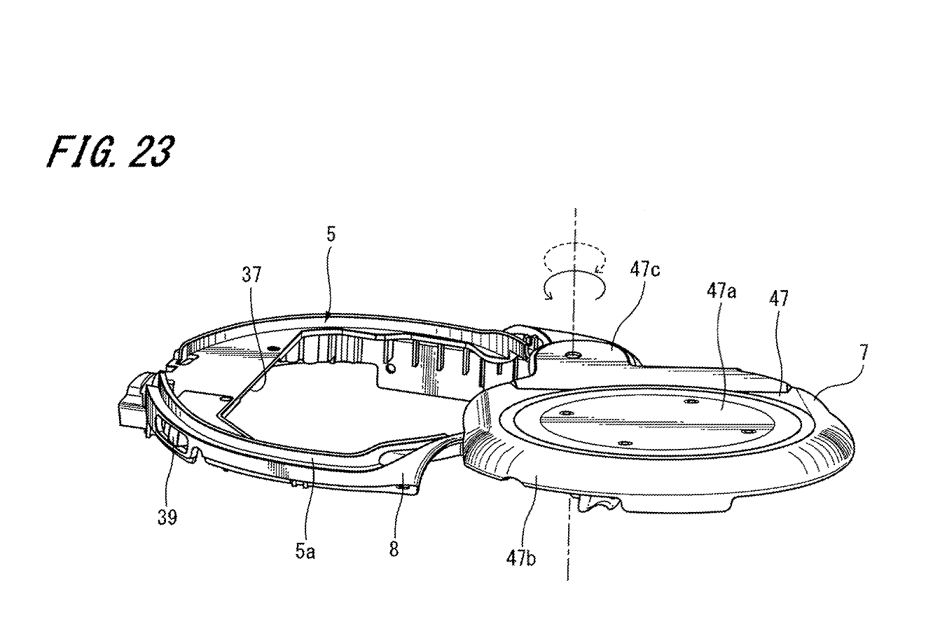

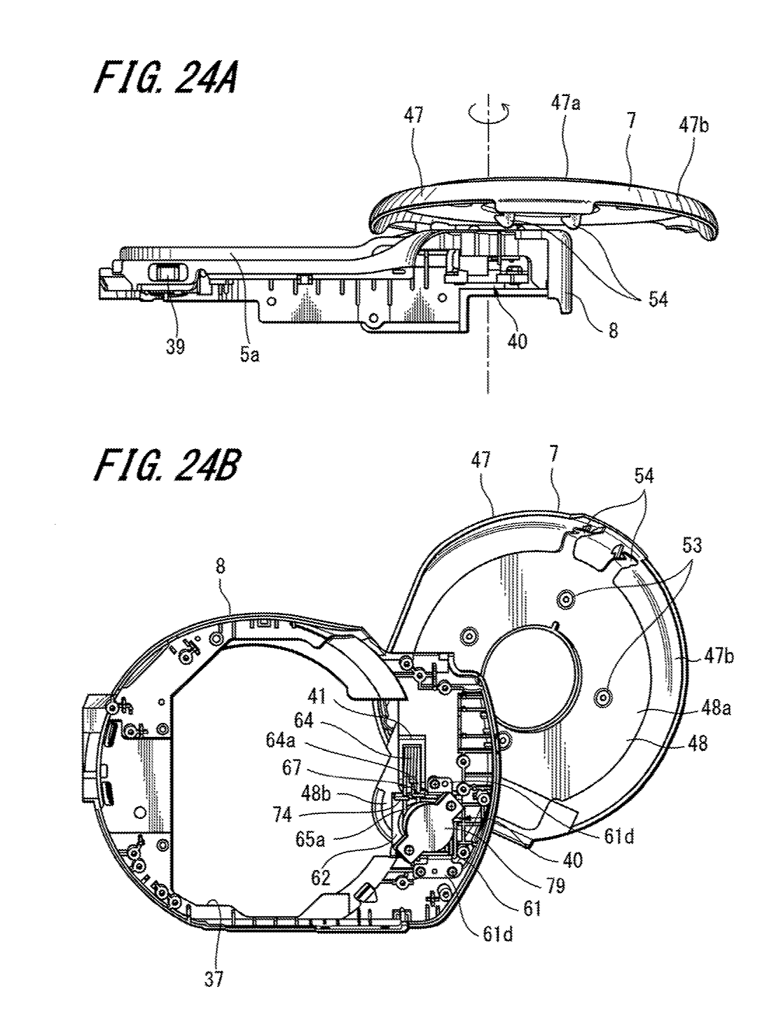

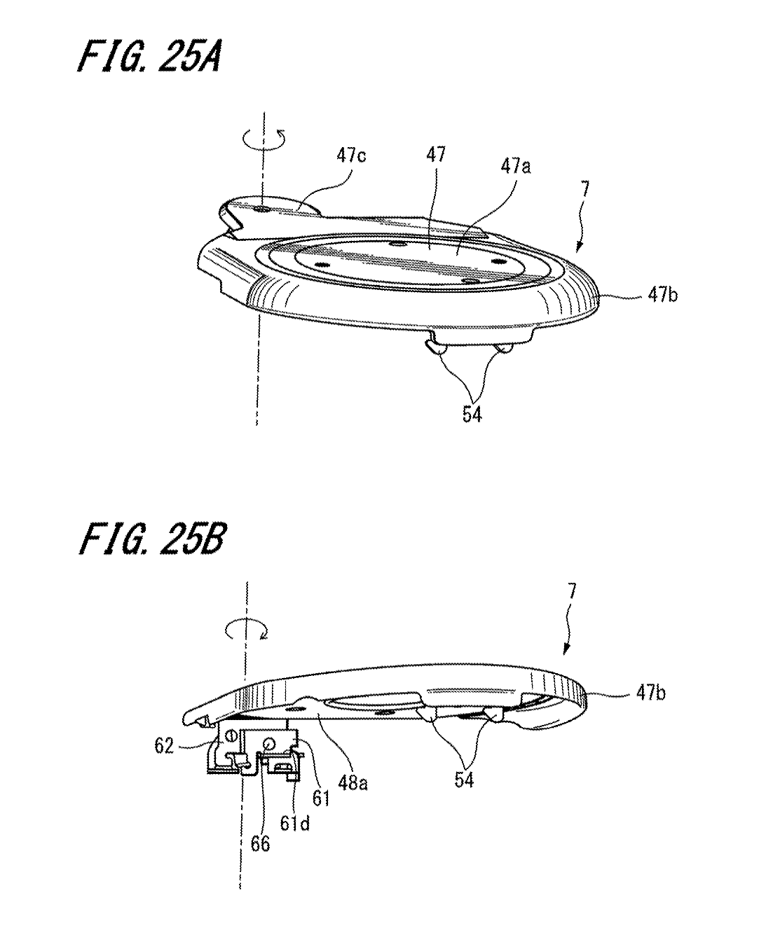

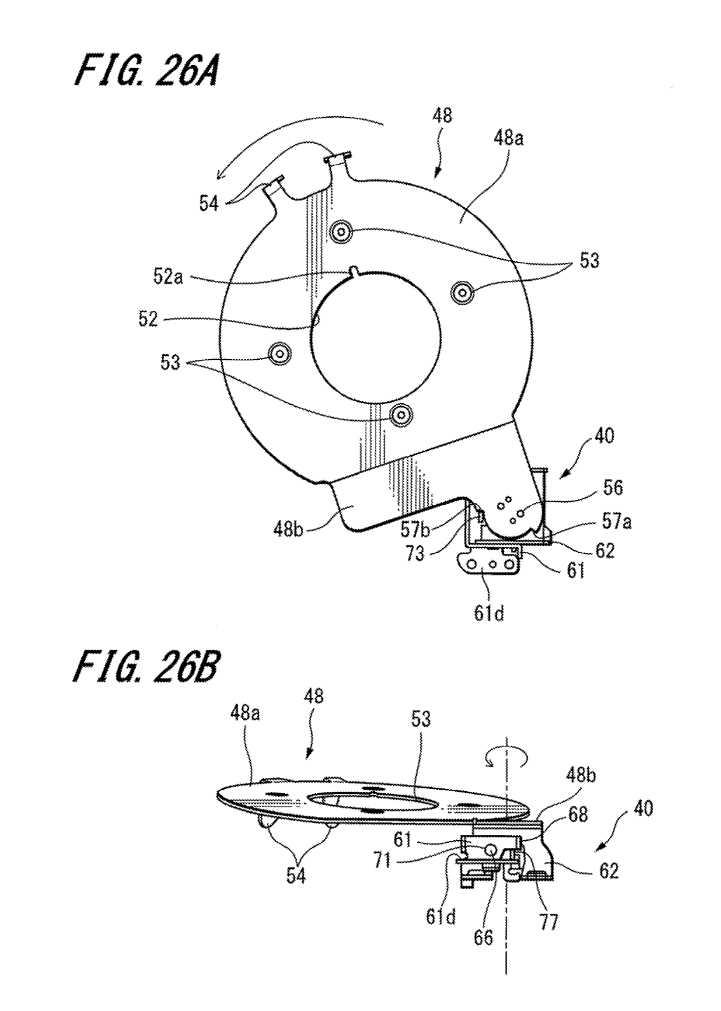

FIGS. 19 to 22 show a state where a cover is moved above a recording medium inserting-ejecting opening, where FIG. 19 is a perspective view; FIG. 20A is a front view; FIG. 20B is a bottom view; FIG. 21A is a perspective view and FIG. 21B is a front view showing a relation between a cover and a shaft support mechanism, respectively; and FIG. 22A is a plan view and FIG. 22B is a front view showing a relation between a plate member and a shaft support mechanism, respectively. FIGS. 23 to 26 show a state where a cover is moved in a direction horizontal to a recording medium inserting-ejecting opening, where FIG. 23 is a perspective view; FIG. 24A is a front view; FIG. 24B is a bottom view; FIG. 25A is a perspective view and FIG. 25B is a front view showing a relation between a cover and a shaft support mechanism, respectively; and FIG. 26A is a plan view and FIG. 26B is a front view showing a relation between a plate member and a shaft support mechanism, respectively.

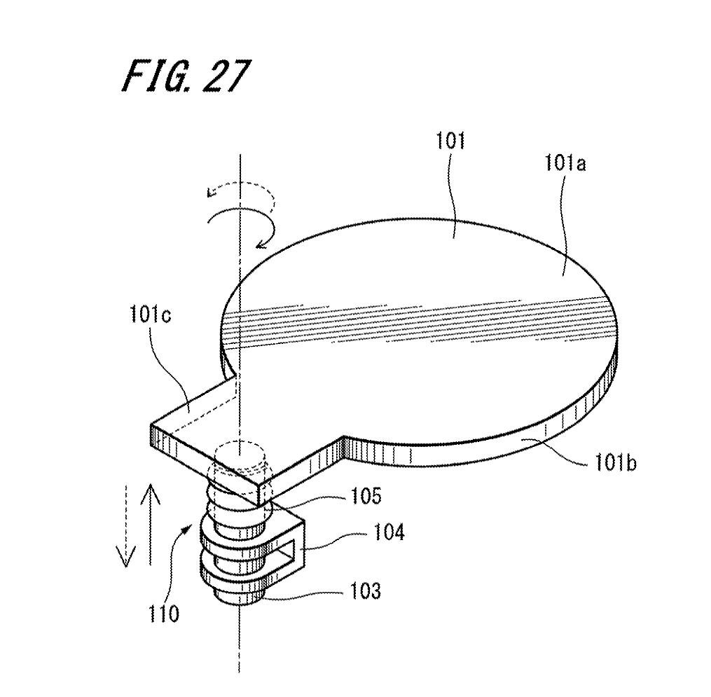

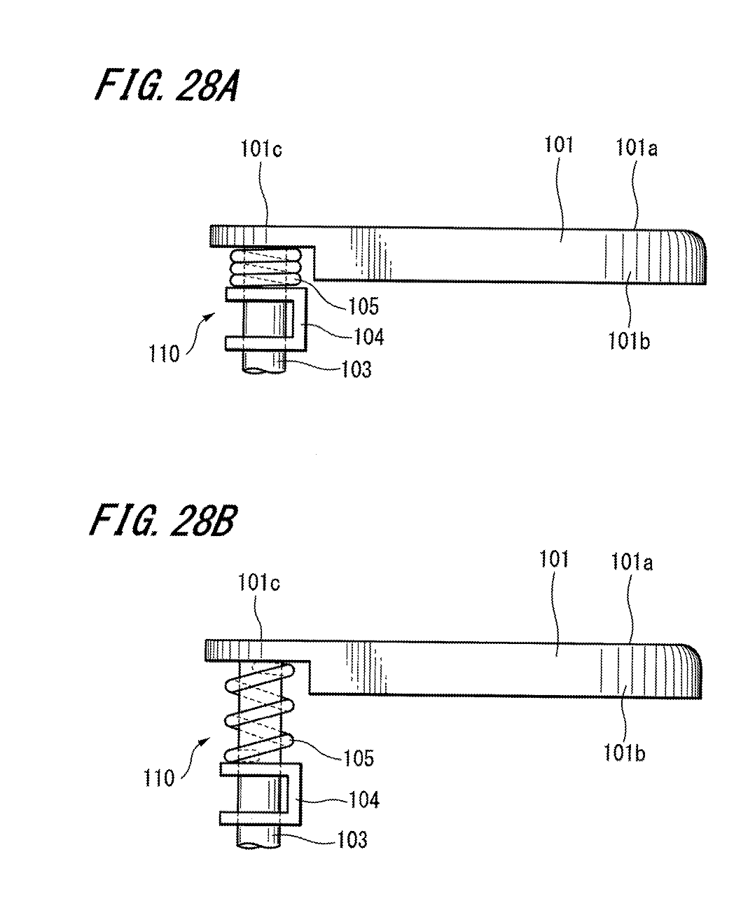

FIGS. 27 and 28 show a cover and a shaft support mechanism in a second example of electronic equipment according to an embodiment, respectively, where FIG. 27 is a schematic view, FIG. 28A is a front view of a state where the cover is closed, and FIG. 28B is a front view of a state where the cover is moved above.

First, an imaging device as a first example of electronic equipment according to an embodiment will be described with reference to FIGS. 1 to 3. The device shown in FIGS. 1 to 3 is a digital camcorder 1 used as a first example of an imaging device. The digital camcorder 1 includes, as an information storage medium, an optical disc 2 that is a specific example of a recording medium, and converts an optical image into electric signals using an imaging element (such as a CCD or CMOS) as a specific example of an imaging mechanism, so that the image information may be recorded on the optical disc and displayed on a display device formed of a flat panel such as a liquid crystal display.

However, a recording medium used in an imaging device as a specific example of electronic equipment according to an embodiment is not limited to optical discs (such as DVD-Rs, DVD-RWs, and DVD-RAMs) shown in this example, and it is possible to use disc-shaped recording media such as recordable magneto-optical discs and magnetic discs including MOs and FDs. Electronic equipment using such a disc-shaped recording medium may be realized as a magneto-optical disc still camera when using a magneto-optical disc; or a magnetic disc electronic organizer when using a magnetic disc, for example.

Recording media that may be used in an embodiment are not limited to the aforementioned disc-shaped recording media, and may be various recording media such as tape-shaped recording media using a magnetic tape, semiconductor recording media using a semiconductor memory, and card-shaped recording media using a memory card.

As shown in FIGS. 1 to 3, the digital camcorder 1 has a disc drive device that rotationally drives the optical disc 2 detachably mounted in the disc drive device to record (write) and reproduce (read) information signals; a control circuit (not shown) to control driving of the disc drive device; a lens device 3 to incorporate an object image as light and guide the image to a solid-state imaging device; an exterior case 4 as a specific example of an enclosure to house the disc drive device; a cover 7 that is rotatably attached to the exterior case 4 and may cover a recording medium inserting-ejecting opening 5 openably and closably; and a display device 6 rotatably attached to the exterior case.

The exterior case 4 is au approximately rectangular parallelepiped hollow enclosure formed of a disc side panel 8 and a display device side panel 9 placed opposite to each other in a transverse direction; and a front panel 11 and a rear panel 12 placed in an optical axis direction of the lens device 3 and combined with the panels 8 and 9. The exterior case 4 has a longitudinal direction set to be a back-and-forth direction and is used as raised in a crosswise direction. The lens device 3 is provided in an upper part of the exterior case 4 in a state where an objective lens 13 as an imaging lens of a lens system is exposed on a front surface. The lens device 3 is attached to the exterior case 4 in a state where an optical axis of the lens system is in a horizontal direction. In the exterior case 4, the solid-state imaging device (not shown) in placed behind the lens device 3 and a viewfinder device 14 is placed behind the solid-state imaging device.

The viewfinder device 14 is exposed in an upper part of the exterior case 4 and has a rear part rotatable up and down around a front side as a rotation center. Accordingly, the viewfinder device 14 may be adjusted to any angle within a predetermined range between a horizontal state where the viewfinder is parallel to an optical axis of the lens device 3 and an upward state where the rear part is raised upward. An opening is provided in the upper part of the external case 4 to expose an accessory shoe having a video light or an external microphone detachably mounted. The accessory shoe is placed immediately in front of the viewfinder device 14 and usually detachably covered with a shoe cap 15 to open and close the opening. Further, an incorporated stereo-type microphone 17 is placed on a front side of the upper part of the exterior case 4.

There are provided a power supply switch 18 also used as a mode selector switch; a shutter button 19 to image a static image; and a zoom button 21 to continuously enlarge (tele) or reduce (wide) an image within a predetermined range above the disc side panel 8 to the right of the view finder device 14. The power supply switch 18 has functions to switch the power supply on and off by a rotational operation and to switch a plurality of function modes to each other to repeat them by performing rotation with the power supply switched on.

As shown in FIG. 1, a battery housing part 23 is provided in an approximate center of the rear panel 12 of the exterior case 4, in which a battery device 22 as a portable power supply is detachably mounted. The battery housing part 23 is placed in an approximate center of a rear surface of the exterior case 4 and is opened backward in the rear panel 12 forming the rear surface of the exterior case 4. A video recording button 24 to image a moving image is placed to the right of the battery housing part 23 on the rear surface of the exterior case 4.

As shown in FIG. 3, a display device 6 is attached to the display device side panel 9 of the exterior case 4 so that an attitude of the display device 6 may be modified. The display device 6 has a flat panel (not shown) formed of a flat liquid crystal display or the like; a panel case 26 to house the flat panel; and a panel support 27 to support the panel case 26 so that an attitude of the panel case 26 may be modified with respect to the exterior case 4. The panel support 27 has a horizontal rotation function to make the panel case 26 rotatable at about 90° in a horizontal direction around a vertical axis as a rotation center; and a back-and-forth rotation function to make the panel case 26 rotatable at about 180° in a back-and-forth direction around a horizontal axis as a rotation center.

Accordingly, the display device 6 may optionally be one of the following attitudes: an attitude where the flat panel is housed in a side surface of the exterior case 4 as shown in FIG. 3; an attitude where the flat panel faces backward by rotating the panel case 26 at 90° from that state; an attitude where the flat panel faces forward by rotating the panel case 26 at 180° from the backward facing state; or an attitude where the flat panel is in an intermediate position among these positions. An operation part 28 formed of a plurality of operation buttons is provided on an upper surface of the exterior case 4 above the display device 6.

As shown in FIGS. 1 and 2, a hand belt 31 is attached to the disc side panel 8 of the exterior case 4. The hand belt 31 supports a hand of a user holding the exterior case 4 to prevent dropping of the digital camcorder 1, for example. The hand belt 31 is formed of a support belt 32 having both edges fixed to the disc side panel 8; and a protection pad 33 attached to the support belt 32 and brought into contact with the back of a hand of a user. One edge of the support belt 32 is fixed to an attachment bracket (not shown) fixed to a front lower part of the disc side panel 8, and another edge is inserted into a through-hole 46 provided in a rear middle part of the disc side panel 8 and fixed to an attachment bracket provided in the through-hole 46.

As shown in FIG. 2, the disc side panel 8 has a disc mounting part 34 having the optical disc 2 detachably mounted; and a turntable of the disc drive device (not shown) in an approximate center of the disc mounting part 34. The disc drive device is supported by the exterior case 4 in that state. The disc drive device rotationally drives the optical disc 2 mounted on the disc mounting part 34 at a predetermined velocity (for example, at a constant linear velocity) and moves an optical pickup device in a radial direction of the optical disc 2 to record (write) and/or reproduce (read) information signals on an information recording surface of the optical disc 2.

As shown in FIGS. 4, 5, and 8, the disc side panel 8 has: the recording medium inserting-ejecting opening 5 through which the optical disc 2 is inserted and ejected; an exposure window 37 to expose part of the disc drive device; an opening 38 to avoid interference with a shaft support mechanism 40 described later; and an operation member 39 and a slide member forming a cover locking device 58. As shown in FIGS. 6A, 6B, and 8, there are provided within the disc side panel 8 a spring housing part 41 to house a first torsion coil spring 64 as a specific example of a first pressing member; and a fixing part 42 to fix a support bracket 61 described later. Further, a side surface of the disc side panel 8 has a guide light hole 43 into which a guide light for operation indication is inserted; a button hole 44 into which the video recording button 24 is inserted; and the belt insertion hole 46 into which the support belt 32 is inserted.

The recording medium inserting-ejecting opening 5 is a round opening slightly larger than the optical disc 2. A side wall 5a to surround the optical disc 2 mounted is provided around the recording medium inserting-ejecting opening 5. The recording medium inserting-ejecting opening 5 is openably and closably covered with the cover 7. As shown in FIGS. 4 and 7, the cover 7 has a shape corresponding to a shape of the recording medium inserting-ejecting opening 5. The cover 7 is formed of a cover member 47 and a sheet-like plate member 48 attached to a rear surface of the cover member 47.

As shown in FIGS. 9A and 9B, the cover member 47 has a round flat surface 47a covering the recording medium inserting-ejecting opening 5 from above in a state where the cover 7 is closed and representing a specific example of a main surface according to an embodiment; a side surface 47b continuous with an approximately entire outer periphery of the flat surface 47a and externally covering the side wall 5a; and an inclined surface 47c continuous with part of the flat surface 47a at a predetermined inclination angle. Since the side wall 5a may be externally covered with the side wall 47b as shown in FIG. 4, the disc side panel 8 may be more tightly closed by the cover 7 and dust may be prevented from entering the recording medium inserting-ejecting opening 5. Accordingly, it is possible to protect the optical disc (recording medium) 2 inserted from the recording medium inserting-ejecting opening 5 and the disc drive device.

The inclined surface 47c has an inclination angle θ determined so that a clearance is formed between the side surface 47b of the cover member and the side wall 5a and the cover 7 is not brought into contact with the hand belt 31 when the inclined surface 47c is approximately parallel to an opening surface of the recording medium inserting-ejecting opening 5, that is, the cover 7 is moved to be opened in a direction approximately perpendicular to the recording medium inserting-ejecting opening 5. Accordingly, the cover 7 may be rotationally moved in a direction approximately horizontal to the recording medium inserting-ejecting opening 5 without interference between the cover 7 and the disc side panel 8.

Screwing holes 49 to fix the plate member 48 are provided on the inclined surface 47c and the flat surface 47a. A guide ring 51 to guide an attachment position of the plate member 49 is further provided on a rear surface of the flat surface 47a. The guide ring 51 has a round shape having a protrusion 51a and protrudes in an attachment direction of the plate member 48.

As shown in FIGS. 10A and 10B, the plate member 48 is formed of a base 48 having a shape approximately equal to that of the flat surface 47a of the cover member 47 and having a size approximately equal to or slightly smaller than that of the flat surface 47a; and an arm 48b continuous with the base 48a at an inclination angle θ equal to that of the inclined surface 47c of the cover member 47. The base 48a has an opening 52 in which the guide ring 51 of the cover member 47 is fitted; screwing holes 53 to fix the plate member 48 to the cover member 47; and a locking part 54 forming the cover locking device 58. The opening 52 has a notch 52a in a position corresponding to the protrusion 51a of the guide ring 51. The screwing holes 53 and their peripheries protrude to have an approximately trapezoidal shape with a predetermined height in a direction in which the cover member 47 is attached.

The arm 48b has insertion holes 56 into which fixing protrusions 85 of a later-described rotation shaft 63 are inserted; and a notch 57 to make the cover 7 rotated around an outer periphery of the rotation shaft 63. The notch 57 has a first notch 57a determining a rotation start point of the cover 7 and a second notch 57b determining a rotation end point of the cover 7 on an outer periphery of the arm 48b with a predetermined interval between the first and second notches 57a and 57b.

The cover 7 may be locked with the recording medium inserting-ejecting opening 5 closed by the cover locking device 58 provided in a part most distant from the insertion holes 56 of the arm 48b in the plate member 48. The cover locking device 58 has the locking part 54 provided in the plate member 48; and the operation member 39 and the slide member slidably attached to the disc side panel 8. The locking part 54 has a locking pawl 54a, while the slide member has a pawl stopper engageable with the locking pawl. The pawl stopper of the slide member is placed on a movement track of the locking pawl 54a by an elastic force of an elastic member such as a spring member.

When the cover 7 is pressed to the disc side panel 8, the locking pawl 54a engaged with the pawl stopper moves the slide member backward against an elastic force of the elastic member. As a result, the pawl stopper overcomes the locking pawl 54a to engage the pawl stopper and the locking pawl 54a to each other. Accordingly, the recording medium inserting-ejecting opening 5 is closed by the cover 7, and the cover 7 is locked to the disc side panel 8. The cover 7 may be unlocked by allowing the operation member 39 to slide in an unlocking direction against an elastic force of the elastic member.

As shown in FIGS. 6A and 6B, there is provided the shaft support mechanism 40 supporting the cover 7 to be movable with respect to the recording medium inserting-ejecting opening 5 on a bottom surface of the disc side panel 8 and the enclosure 7. The shaft support mechanism 40 is formed of an axial movement part 50 to move the cover 7 in a direction approximately perpendicular to the recording medium inserting-ejecting opening 5; and a circumferential movement part 60 to move the cover 7 approximately horizontally to the recording medium inserting-ejecting opening 5.

The axial movement part 50 has: the approximately U-shaped support bracket 61; an approximately U-shaped rotation bracket 62; a hinge shaft 66 rotatably connecting the support bracket 61 to the rotation bracket 62; and the first torsion coil spring 64 as a specific example of a first pressing member according to an embodiment. The circumferential movement part has: the rotation shaft 63; and a second torsion coil spring 65 as a specific example of a second pressing member according to an embodiment.

As shown in FIGS. 7 and 11, the support bracket 61 has an approximately U-shape, an approximately rectangular first wall 61a; a second wall 61b continuously formed from one end of a longitudinal direction of the first wall 61a with an approximately rectangular bend; and a third wall 61c continuously formed from one end of another end of the longitudinal direction of the first wall 61a and opposed to the second wall 61b.

The second wall 61b has a hook piece 67 engaged with a spring leg 64a on one edge of the first torsion coil spring 64. The hook piece 67 is provided above and continuous with the second wall 61b. A projection piece 68 is provided externally in a plane direction from and approximately perpendicularly continuous with an edge of the third wall 61c opposed to an edge of the third wall 61c continuous with the first wall 61a. The projection piece 68 is brought into contact with a stopper piece 77 of the rotation bracket 62 to stop rotation of the rotation bracket 62.

The second wall 61b and the third wall 61c each have a fastening surface 61d approximately perpendicularly continuous with a predetermined position of an upper edge of the wall. The fastening surface 61d has a plurality of fixing holes 69 to screw and fix the fastening surface 61d to the fixing part 42 of the disc side panel 8. A fastening surface of the fastening surface 61d is fixed to the disc side panel 8 and therefore approximately parallel to the opening surface of the recording medium inserting-ejecting opening 5. As shown in FIGS. 17 and 18 with the cover 7 closed, the fastening surface of the fastening surface 61d is approximately parallel to the flat surface 47a of the cover member 47 and the base 48a of the plate member 48. Further, the second wall 61b and the third wall 61c each have a bearing 71 into which the hinge shaft 66 is inserted.

This example describes a case where the support bracket 61 and the disc side panel 8 are formed of separate members; however, the present embodiment is not limited to this example. The support bracket 61 and the disc side panel 8 may be formed of an identical member.

As shown in FIGS. 7 and 12, the rotation bracket 62 is approximately U-shaped and formed of a quadrangular bottom surface 62a; a first side surface 62b approximately perpendicularly continuous with one edge of the bottom surface 62a; and a second side surface 62c approximately perpendicularly continuous with another edge of the bottom surface 62a and opposed to the first side surface 62b.

There is provided in a center of the bottom surface 62a a through-hole 72 into which a cylindrical projection 83 of the later-described rotation shall 63 is inserted. A protrusion 73 below and continuous with the bottom surface 62a is provided on one edge of the bottom surface 62a not continuous with the first and second side surfaces 62b and 62c. The protrusion 73 determines a range in which the cover 7 is moved in a direction approximately horizontal to the recording medium inserting-ejecting opening 5. The protrusion 73 is brought into contact with the first notch 57a provided in the plate member 48 before rotating the cover 7 to be opened approximately horizontally to the recording medium inserting-ejecting opening 5. The protrusion 73 is brought into contact with the second notch 57b of the plate member 48 in a predetermined position to stop rotation of the cover 7, when the cover 7 is rotated to be opened approximately horizontally to the recording medium inserting-ejecting opening 5.

The first side surface 62b has: a hook piece 74 engaged with a spring leg 65a on one edge of the second torsion coil spring 65 as a second pressing member; and an insertion hole 75 into which a spring leg 64b on another edge of the first torsion coil spring 64 is inserted. The hook piece 74 is provided above and continuous with the first side surface 62b. The second side surface 62c has the stopper piece 77 protruding to outside in a plane direction of the second side surface 62c. The stopper piece 77 is brought into contact with the projection piece 68 provided in the support bracket 61 when the rotation bracket 62 is rotated around the hinge shaft as a rotation center, so that the stopper piece 77 stops rotation of the rotation bracket 62. The stopper piece 77 is placed on the second side surface 62c at a height determined so that the inclined surface 47c of the cover member 47 and the arm 48b of the plate member 48 are brought into contact with the projection piece 68 of the support bracket 61 in positions approximately parallel to the opening surface of the recording medium inserting-ejecting opening 5.

The stopper piece 77 is preferably placed on the second side surface 62c at a height determined so that the side surface 47b of the cover member 47 overcomes the side wall 5a and is brought into contact with the projection piece 68 of the support bracket 61 in a position where an upper surface of the flat surface 47a of the cover member 47 is not brought into contact with the hand belt 31, when the cover 7 is moved to be opened in a direction approximately perpendicular to the recording medium inserting-ejecting opening 5.

The first side surface 62b and the second side surface 62c each have a seating 78 approximately perpendicularly continuous with a predetermined position on an upper edge of the side surface. As shown in FIG. 14, a damper 79 is fixed to the seating 78 to control a speed of rotating the cover 7 to be opened approximately horizontally to the recording medium inserting-ejecting opening of the cover 7. The first side surface 62b and the second side surface 62c each have a bearing 81 into which the hinge shaft 66 is inserted in a position corresponding to the bearing 71 of the support bracket 61.

As shown in FIGS. 13 and 14, the hinge shaft 66 is inserted into the bearings 71 and 81 provided in the support bracket 61 and the rotation bracket 62, so that the rotation bracket 62 is rotatably connected to the support bracket 61. The hinge shaft 66 has a shaft center line approximately parallel to the opening surface of the recording medium inserting-ejecting opening 5.

As shown in FIG. 15, the rotation shaft 63 is cylindrical. One end surface 63a of the rotation shaft 63 has a recess 82 in which a projection 79a of the damper 79 is fitted. Another end surface 63a of the rotation shaft 63 has the cylindrical projection 83 cylindrically protruding to outside in an axial direction. The cylindrical projection 83 has a groove 84 into which a spring leg 65b on another edge of the second torsion coil spring 65 is inserted. The groove 84 is engaged with the spring leg 65b of the second torsion coil spring 65 to mount the second torsion coil spring 65 on the rotation shaft 63. The cylindrical projection 83 has the plurality of fixing protrusions 85 inserted into the insertion holes 56 of the plate member 47. As shown in FIG. 16, the rotation shaft 63 is rotatably supported by the rotation bracket 62 by inserting the cylindrical projection 83 into the through-hole 72 of the rotation bracket 62.

As shown in FIGS. 6 and 14, the first torsion coil spring 64 is housed in the spring housing part 41 provided in the disc side panel 8. The spring leg 64a on the one edge of the first torsion coil spring 64 is engaged with the hook piece 67 of the support bracket 61 and the spring leg 64b on the other edge of the first torsion coil spring 64 is inserted into and thus engaged with the insertion hole 75 of the rotation bracket 62 with a torsional moment applied to the first torsion coil spring 64. Here, the support bracket 61 is fixed to the disc side panel 8. As a result, the rotation bracket 62 is continuously pressed in a direction intersecting an axial direction of the hinge shaft 66 by a pressing force of the first torsion coil spring 64. Further, the bottom surface 62a of the rotation bracket 62 rotatably connected to the support bracket 61 is brought into contact with the plate member 48 forming the cover 7. Accordingly, the cover 7 is continuously pressed in a direction intersecting an axial direction of the hinge shaft 66, that is, in a direction to open the cover 7 in a direction approximately perpendicular to the recording medium inserting-ejecting opening 5 by a pressing force of the first torsion coil spring 64.

As shown in FIGS. 6 and 14, the spring leg 65a on the one edge of the second torsion coil spring 65 is engaged with the hook piece 74 of the rotation bracket 62 with a torsional moment applied to the second torsion coil spring 65. The spring leg 65b on the other edge of the second torsion coil spring 65 is directed inside the coil spring 65 in a radial direction and is engaged with the groove 84 of the rotation shaft 63. Here, the cylindrical projection 83 of the rotation shaft 63 is inserted into the through-hole 72 of the rotation bracket 62, and the rotation shaft 63 is rotatably supported by the rotation bracket 62. Further, the fixing protrusions 85 of the rotation shaft 63 are inserted into the insertion holes 56 of the plate member 48, and the rotation shall 63 is screwed to and thus integrally fixed to the cover 7. Accordingly, the rotation shaft 63 is continuously pressed to be rotated around the shaft center line of the rotation shaft 63 as a rotation center by a pressing force of the second torsion coil spring. That is, the cover 7 is continuously pressed to be opened approximately horizontally to the recording medium inserting-ejecting opening 5 by a pressing force of the second torsion coil spring 65.

The cover 7 and the shaft support mechanism 40 having such a configuration may be assembled as follows, for example. First, as shown in FIG. 13, the hinge shaft 66 is inserted into the bearings 71 and 81 provided in the support bracket 61 and the rotation bracket 62, so that the rotation bracket 62 is rotatably connected to the support bracket 61. Then, the spring leg 64a on the one edge of the first torsion coil spring 64 is engaged with the hook piece 67 of the support bracket 61 and the spring leg 64b on the other edge is inserted into the insertion hole 75 of the rotation bracket 62 with a torsional moment applied to the first torsion coil spring 64. Accordingly, the axial movement part 50 is formed having the support bracket 61, the rotation bracket 62, the hinge shaft 66, and the first torsion coil spring 64 integrated.

The axial movement part 50 is fixed to the disc side panel 8. Specifically, the fastening surface 61c of the support bracket 61 is fixed to the fixing part 42 of the disc side panel 8 by screwing. The first torsion coil spring 64 is housed in the spring housing part 41 of the disc side panel 8 at the same time. Here, the fastening surface of the fastening surface 61c of the support bracket 61 is approximately parallel to the opening surface of the recording medium inserting-ejecting opening 5.

Next, as shown in FIG. 15B, the spring leg 65b on the other edge of the second torsion coil spring 65 is inserted into the groove 84 of the rotation shaft 63 to mount the second torsion coil spring 65 on the rotation shaft 63. Accordingly, the circumferential movement part 60 is formed having the rotation shaft 63 and the second torsion coil spring 65 integrated. Then, as shown in FIG. 15A, the cylindrical projection 83 of the rotation shaft 63 forming the circumferential movement part 60 is inserted into the through-hole 72 of the rotation bracket 62. At the same time, the fixing protrusions 85 of the rotation shaft 63 are inserted into the insertion holes 56 of the plate member 48 and the rotation shaft 63 is fixed by a fixing device such as a screwing device. Accordingly, the rotation shaft 63 and the plate member 48 are integrated, and the rotation shaft 63 is rotatably supported by the rotation bracket 62. Here, the spring leg 65a on the one end of the second torsion coil spring 65 is engaged with the hook piece 74 of the rotation bracket 62 with a torsional moment applied to the second torsion coil spring 65.

Next, the guide ring 51 of the cover member 47 is fitted in the opening 52 of the plate member 48, and the cover member 47 is fixed to the plate member 48 by a fixing device such as a screwing device. The projection 79a of the damper 79 is fitted in the recess 82 of the rotation shaft 63, and the damper is fixed to the seating 78 of the rotation bracket 63 by screwing. Consequently, the cover 7 and the shaft support mechanism 40 are completely assembled.

The cover 7 formed in this manner is opened and closed as follows, for example. The cover 7 is opened by releasing a pressing force of the first torsion coil spring 64 and the second torsion coil spring 65 forming the shaft support mechanism 40.

Here, the spring leg 64a on the one edge of the first torsion coil spring 64 is engaged with the hook piece 67 of the support bracket 61 and the spring leg 64b on the other edge is inserted into the insertion hole 75 of the rotation bracket 62 with a torsional moment applied to the first torsion coil spring 64. Here, the support bracket 61 is fixed to the disc side panel 8. As a result, the rotation bracket 62 is continuously pressed in a direction intersecting an axial direction of the hinge shaft 66 by a pressing force of the first torsion coil spring 64.

Further, the spring leg 65a on the one edge of the second torsion coil spring 65 is engaged with the hook piece 74 of the rotation bracket 62 and the spring leg 65b on the other edge is inserted into the groove 84 of the rotation shaft 63 with a torsional moment applied to the second torsion coil spring 65. Here, the cylindrical projection 83 of the rotation shaft 63 is inserted into the through-hole 72 of the rotation bracket 62, and the rotation shaft 63 is rotatably supported by the rotation bracket 62. Further, the rotation shaft 63 is integrally fixed to the plate member 48 forming the cover 7. As a result, the rotation shaft 63 and the plate member 48 (cover 7) are continuously pressed to be rotated around the shaft center line of the rotation shaft 63 as a rotation center by a pressing force of the second torsion coil spring 65.

When the operation member 39 slides in an unlocking direction against an elastic force of the elastic member to unlock the cover locking device 58, the rotation bracket 62 is rotated around the hinge shaft 66 as a rotation center by a pressing force of the first torsion coil spring 64. Here, since the bottom surface 62a of the rotation bracket 62 is brought into contact with the plate member 48, the plate member 48 (cover 7) is moved approximately perpendicularly away from the recording medium inserting-ejecting opening 5 as shown in FIGS. 19 to 22.

As shown in FIG. 22B, the rotation bracket 62 is stopped being moved in a rotation direction when the stopper piece 77 provided in the rotation bracket 62 is brought into contact with the projection piece 68 provided in the support bracket 61. At the same time, the plate member 48 (cover 7) stops being moved to be opened in a direction approximately perpendicular to the recording medium inserting-ejecting opening 5. Here, as shown in FIGS. 20A, 21B, and 22B, the inclined surface 47c of the cover member 47 and the arm 48b of the plate member 48 which form the cover 7 are approximately parallel to the opening surface of the recording medium inserting-ejecting opening 5 and the fastening surface of the fastening surface 62d of the support bracket 61. Here, an inclination angle θ is determined so that a clearance is formed between the side surface 47b of the cover member 47 and the side wall 5a and the cover 7 is not brought into contact with the hand belt 31 when the inclined surface 47c is approximately parallel to the opening surface of the recording medium inserting-ejecting opening 5. Accordingly, the cover 7 may be moved above the recording medium inserting-ejecting opening 5 to a position where the cover 7 does not interfere with the disc side panel 8 and is not brought into contact with the hand belt 31.

This example describes a case where the rotation bracket 62 (cover 7) is rotated until the inclined surface 47c of the cover member 47 and the arm 48b of the plate member 48 are approximately parallel to the opening surface of the recording medium inserting-ejecting opening 5 and the fastening surface of the fastening surface 62d of the support bracket 61; however, the present embodiment is not limited to this example. For example, the cover 7 may be moved approximately perpendicularly away from the recording medium inserting-ejecting opening 5 to a position where the side surface 47b of the cover member overcomes the side wall 5a and the upper surface of the flat surface 47b is not brought into contact with the hand belt 31.

A pressing force of the second torsion coil spring 65 is released to rotate the rotation shaft 63 around the shaft center line of the rotation shaft 63. Here, the rotation shaft 63 is fixed to the plate member 48 forming the cover 7. As a result, the plate member 48 (cover 7) is rotationally moved approximately horizontally away from the recording medium inserting-ejecting opening 5 as shown in FIGS. 23 to 26. Here, the cover 7 is previously moved in a direction approximately perpendicular to the recording medium inserting-ejecting opening 5. As a result, the cover 7 may be moved approximately horizontally away from the recording medium inserting-ejecting opening 5 without bringing the side wall 5a into contact with the side surface 47b.

As shown in FIG. 26A, when the protrusion 73 provided in the rotation bracket 62 is brought into contact with the second notch 57b provided in the plate member 48, a rotational operation to open the plate member 48 (cover 7) approximately horizontally to the recording medium inserting-ejecting opening 5 is stopped, and the cover 7 is opened. Accordingly, a user may open the cover 7 by a single operation of allowing the operation member 39 to slide in an unlocking direction. Furthermore, since the cover 7 is opened approximately horizontally to the recording medium inserting-ejecting opening 5 as shown in FIG. 2, the cover 7 does not hit a user in the hand or arm when exchanging the optical disc 2 (recording medium). In addition, the cover 7 only passes through a small space when opened, and the cover 7 may be opened even in a narrow space.

In order to close the opened cover 7, the cover 7 is first rotated to be closed approximately horizontally to the recording medium inserting-ejecting opening 5 against a pressing force of the second torsion coil spring 65 forming the circumferential movement part 60. Then, as shown in FIG. 22A, the cover 7 is moved to a position where the protrusion 73 of the rotation bracket 62 is brought into contact with the first notch 57a of the plate member. Here, as shown in FIGS. 19, 20A, and 20B, the cover 7 is placed above the opening surface of the recording medium inserting-ejecting opening 5.

Then, the cover 7 is pressed to the disc side panel 8 against a pressing force of the first torsion coil spring 64 forming the axial movement part 50. Here, the locking pawl 54a engaged with the pawl stopper forming the cover locking device 58 moves the slide member backward against an elastic force of the elastic member of the cover locking device 58. As a result, the pawl stopper overcomes the locking pawl 54a to engage the pawl stopper and the locking pawl 54a to each other. Accordingly, the recording medium inserting-ejecting opening 5 is closed by the cover 7, and the cover 7 is locked to the disc side panel 8.

Here, the cover 7 may be moved approximately perpendicularly away from the recording medium inserting-ejecting opening by rotating the rotation bracket 62 around the hinge shaft with respect to the support bracket 61. Accordingly, the cover 7 may be extremely smoothly closed even by pressing any place on the upper surface of the flat surface 47a, for example, a part most distant from the shaft support mechanism 40 when the cover 7 is pressed to the disc side panel 8.

FIGS. 27, 28A and 28B show a cover and a shaft support mechanism in a second example of electronic equipment according to an embodiment. The cover 101 and the shaft support mechanism 110 differ from the cover 7 and the shaft support mechanism 40 of the first example in that a compression coil spring 105 as a second example of a first pressing member is used for moving the cover 101 in a direction approximately perpendicular to a recording medium inserting-ejecting opening 5 and the cover 101 does not have an inclined surface 47b. As other components are the same as in the first example, the different components will be particularly described.

In this example, as shown in FIGS. 27, 28A, and 28B, the cover 101 is formed of a round flat surface 101a; a side surface 101b continuous with an approximately entire outer periphery of the flat surface 101a and externally covering a side wall 5a of the recording medium inserting-ejecting opening 5; and a square part 101c horizontally continuous with part of the flat surface 101a. The shaft support mechanism 110 is provided below the square part 101c. A cover locking device (not shown) is provided in a part most distant from the square part 101c and locked to a disc side panel with the cover 101 closed.

The shaft support mechanism 110 of this example is formed of a rotation shaft 103 connected to a bottom surface of the square part 101c; a bearing 104 rotatably supporting the rotation shaft 103; and the compression coil spring 105 pressing the cover 101 perpendicularly to the recording medium inserting-ejecting opening.

The rotation shaft 103 has one edge fixed to the bottom surface of the square part 103c of the cover 7 and another edge inserted into and rotatably supported by the disc side panel (not shown). The bearing 104 is formed as approximately U-shaped and the rotation shaft 103 is rotatably inserted into centers of two surfaces of the bearing 104 opposed to each other. The compression coil spring 105 is mounted on the rotation shaft 103 and is present between the square part 101c and the bearing 104 in a compressed state as shown in FIGS. 27 and 28A. The compression coil spring 105 has a spring leg on one edge engaged with the square part 101c and a spring leg on another edge engaged with the bearing 104. The cover 7 is continuously pressed perpendicularly to the recording medium inserting-ejecting opening and away from the recording medium inserting-ejecting opening by a pressing force of the compression coil spring 105.

The cover 101 is opened and closed by the shaft support mechanism 110 having such a configuration as follows, for example. First, the cover locking device (not shown) in unlocked to release a pressing force of the compression coil spring 105 forming the shaft support mechanism 110, so that the cover 101 is moved axially above the rotation shaft 104 by the pressing force of the compression coil spring 105 as shown in FIG. 28B. That is, the cover 101 is moved perpendicularly away from the recording medium inserting-ejecting opening. Here, the cover 101 is set to be moved above the recording medium inserting-ejecting opening to a position where the side surface 101b overcomes a side wall (not shown) and the flat surface 101a is not brought into contact with a hand belt. Then, the cover 101 is moved to a predetermined position in a circumferential direction of the rotation shaft 103 around the rotation shaft 103 as a rotation center. That is, the cover 101 is moved horizontally with respect to the recording medium inserting-ejecting opening. Accordingly, the cover 101 may be opened.

In order to close the opened cover 101, the cover 101 is moved above an opening surface of the recording medium inserting-ejecting opening in the circumferential direction of the rotation shaft 103 around the rotation shaft 103 as a rotation center. Then, the cover 101 is pressed to the disc side panel against a pressing force of the compression coil spring 105 to lock the cover 101 to the cover locking device. Here, the cover 101 may be extremely smoothly pressed to the disc side panel by pressing a position of the square part 101c above the rotation shaft 103. The cover 101 and the shaft support mechanism 110 having such a configuration may also exhibit the same effect as in the cover 7 and the shaft support mechanism 40 of the aforementioned first example.

The shaft support mechanism 110 of the second example is formed of the rotation shaft 103, the bearing 104, and the compression coil spring 105, and therefore may have a simpler structure than in the first example and may have a reduced number of components.

As described above, electronic equipment according to an embodiment includes a shaft support mechanism to move a cover in a direction approximately perpendicular to a recording medium inserting-ejecting opening to a predetermined position and to move the cover horizontally to the recording medium inserting-ejecting opening. Accordingly, the cover may be opened and closed without being brought into contact with a hand belt provided in a disc side panel. Further, the hand belt may be shifted from an opening surface of the recording medium inserting-ejecting opening in the middle of opening the cover, and the hand belt does not hinder exchange of a recording medium.

Since the cover is first moved in a direction approximately perpendicular to the recording medium inserting-ejecting opening and then moved in a direction approximately horizontal to the recording medium, the cover may be moved without interference with the disc side panel (enclosure). As a result, since the cover may have a side surface externally covering a side wall of the disc side panel (enclosure), the recording medium inserting-ejecting opening of the disc side panel (enclosure) may be completely covered even if the side wall has a notch. Therefore, the disc side panel (enclosure) may be more tightly covered with the cover, and dust from outside may be effectively prevented from entering the disc side panel. Further, since a rotation center of the cover may be located in any position in the disc side panel (enclosure), the equipment itself may be reduced in size.

Since the cover is opened and closed approximately parallel to the opening surface of the recording medium inserting-ejecting opening, the cover does not hit a user in the hand or arm when exchanging a recording medium, and the user may be much less bothered. In addition, the cover only passes through a small space when opened and closed, and the cover may be opened and closed even in a narrow space.

The present application is not limited to the embodiment described above and shown in the drawings, and various modifications may be realized. For example, as described above, electronic equipment according to an embodiment is a digital camcorder; however, the electronic equipment may be not only a digital camcorder, obviously, but also various other types of electronic equipment such as an electronic still camera, a personal computer, an electronic dictionary, a DVD player, and a car navigation system.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. Electronic equipment comprising:
an enclosure having a recording medium inserting-ejecting opening through which a recording medium inserted and ejected;
a cover that capable of opening and closing the recording medium inserting-ejecting opening; and
a shaft support mechanism supporting the cover movable with respect to the enclosure,
the shaft support mechanism having an axial movement part supporting the cover that is movable in a direction approximately perpendicular to the recording medium inserting-ejecting opening; and a circumferential movement part supporting the cover that is movable in a direction approximately horizontal to the recording medium inserting-ejecting opening.

2. Electronic equipment according to claim 1, wherein
the axial movement part has
a support bracket fixed to the enclosure;
a rotation bracket rotatably connected to the support bracket through a hinge shaft; and
a first pressing member that presses the rotation bracket in a direction intersecting an axial direction of the hinge shaft to press the cover in a direction to open the cover with respect to the recording medium inserting-ejecting opening.

3. Electronic equipment according to claim 1, wherein
the circumferential movement part has
a rotation shaft fixed to the cover; and
a second pressing member that presses the rotation shaft in a direction to rotate the rotation shaft around a shaft center line of the rotation shaft to press the cover in a direction to open the cover with respect to the recording medium inserting-ejecting opening.

4. Electronic equipment according to claim 1, wherein
the cover has a main surface that may open and close the recording medium inserting-ejecting opening; and an inclined surface continuously and integrally formed with the main surface at a predetermined inclination angle to the main surface, and
the inclination surface is directed in a direction approximately perpendicular to a rotation center axis of the cover when the circumferential movement part rotates the cover.

5. Electronic equipment according to claim 1, wherein
the cover has a side surface externally covering a side wall of the enclosure with the recording medium inserting-ejecting opening closed.
